(19) United States
(12) Patent Application Publication
(10) Pub. No.: US 2013/0173435 A1
(43) Pub. Date: Jul. 4, 2013

(54) SYSTEMS AND METHODS FOR MANAGING PRODUCT LOCATION INFORMATION

(71) Applicant: Thomas Michael Cozad, JR., Seattle, WA (US)

(72) Inventor: Thomas Michael Cozad, JR., Seattle, WA (US)

(21) Appl. No.: 13/713,962

(22) Filed: Dec. 13, 2012

Related U.S. Application Data
(60) Provisional application No. 61/576,616, filed on Dec. 16, 2011.
(60) Provisional application No. 61/655,889, filed on Jun. 5, 2012.
(60) Provisional application No. 61/694,503, filed on Aug. 29, 2012.
(60) Provisional application No. 61/719,884, filed on Oct. 29, 2012.

(51) Int. Cl. G06Q 10/08

(52) U.S. Cl. CPC G06Q 10/087
USPC 705/28

(57) ABSTRACT

Techniques for managing product location information are described. Managing product location information may include collecting, storing, generating, and synthesizing information about the location of products or other items in a store, retail location, warehouse, or other location. In one embodiment, a user operates a mobile device (e.g., scanner, smart phone) to efficiently scan item identifiers corresponding to items on the shelves of a store. In some cases, the user need only scan a single item identifier in a section or shelf, which is then used to obtain information about other items in that section, such as based on a planogram or other store inventory information. In some embodiments, shelves, sections, and/or aisles include location identifiers that can be scanned in order to reset, save, and/or initialize a record that stores information about products located at that shelf, section, or aisle.

### TECHNICAL FIELD

The present disclosure relates to methods, techniques, and systems for inventory management and, more particularly, to methods, techniques, and systems for managing product location information for items located on shelves in a store or other location.

### BRIEF DESCRIPTION OF THE DRAWINGS

FIG. 1.1 is an example block diagram illustrating product location information management according to a first example embodiment.

FIG. 1.2 is an example user interface screen for a mobile device configured to facilitate collection of store aisle location information according to the first example embodiment.

FIG. 2.1 is an example block diagram illustrating product location information management according to a second embodiment.

FIG. 2.2 is an example user interface screen for a digital device configured to facilitate generation of relationships between ASSL and store data according to the second example embodiment.

FIG. 2.3 is an example store layout generated and presented by the second example embodiment.

FIG. 3.1 is an example block diagram illustrating product location information management according to a third example embodiment.

FIGS. 3.2A-3.2H are example user interface screens for product location information management and search according to the third example embodiment.

FIG. 4.1 is an example block diagram illustrating product location information management according to a fourth example embodiment.

FIG. 4.2 is an example of the SEC smart location device configured to facilitate collection of product aisle location information according to the fourth example embodiment.

FIG. 4.3 is an example user interface screen for a mobile device configured to facilitate collection of store aisle location information according to the fourth example embodiment.

FIG. 4.4 is an example command strip configured to facilitate collection of product location information in example embodiments.

FIGS. 5.1-5.43 are example flow diagrams of product location information management processes performed by example embodiments.

FIG. 6 is an example block diagram of an example computing system for implementing example embodiments.

### DETAILED DESCRIPTION

Embodiments described herein provide enhanced computer- and network-based methods and systems for inventory management and, more particularly, to methods, techniques, and systems for managing product location information. Product location information management may include collecting, storing, generating, and synthesizing information about the location of products or other items in a store, retail location, warehouse, or other location.

In one embodiment, the mobile device receives an indication of an initial position in a store. Then the mobile device receives a series of item identifiers that each correspond to one of multiple items located on a shelf in the store. Typically, the item identifiers are received from a scanner (e.g., barcode scanner, RFID scanner) operated by a user who is traversing the shelf and scanning one item after another. The mobile device sends (e.g., to a remote server) and/or records each item's unique location and then receives an indication that the user has reached the end of the shelf (or section), at which point the mobile device prepares to set or adjust store aisle location information for a next group of items without any additional input from the user. In this manner, the user can scan one shelf after another with minimal inputs (typically just an indication of a beginning or end of shelf) to the mobile device, and without any manual entry of store aisle location information (e.g., product identifier, shelf number, aisle number, section number, etc.).

Some embodiments provide methods and systems for establishing a store's aisle/side/section pattern and to then assign those variables when store aisle location information for items is collected or provided by a store having information that does not contain an aisle/side/section/shelf/itemization order relationship. Store data and/or Planograms (“POGs”) are identified, imported and automatically assigned that location's aisle/side/section/shelf/itemization order. Example embodiments provide a digital computing device (e.g., tablet computer, laptop computer, slate, smart phone) configured to efficiently generate PAL (“Product Aisle Location”) information for items (sometimes also called “products” herein) located on shelves positioned in an aisle and side. In one embodiment, the digital device receives an indication of an initial position in a store. Then the digital device receives a series of item identifiers that each correspond to shelved products in order to (1) generate a section count on an aisle's side, (2) identify store data information (including POGs), (3) import that store data information (e.g., a POG record) into a correct section, (4) automatically creates an interactive aisle side section map for PAL maintenance going forward. Typically, the item identifiers are received from a scanner (e.g., barcode scanner, RFID scanner) or typed in a keyboard operated by a user who is traversing the aisle and side scanning one item in each section until the end of the aisle is reached based upon the user's intention of the exercise (e.g., to establish or update a store's aisle/side/section structure). The device records the aisle/side/section count and identification information and then receives an indication that the user has reached the end of the section, at which point the device records that store's aisle/side/section count for that unique aisle side while importing any known store data found in the exercise which may import one or many items in a section. This unique map of the aisle/side/section count for an aisle side is dynamically generated, and can be dynamically increased or decreased, by the user interacting with this invention. PAL information for each of the multiple items related to a store's generated aisle/side/section data will automatically adjust the PAL attributes for the next items, groups of products, without any additional input from the user. In this manner, the user can scan one product in a section continue to enter one product in a section (upright) after another, with minimal inputs (typically just an indication of a beginning or end of an aisle) to the device, and without any manual entry of PAL information (e.g., product identifier, shelf number, item count number, etc.). The total result of this aisle/side/section generation is a store layout based upon that location's unique aisle/side/section layout for viewing and updating.

In one embodiment, a product location information management system is provided. The system is configured to receive product location information from hand-held scanning devices deployed in the field (e.g., at a store) for collecting location information for products carried by the store. This information may be merged and/or processed in conjunction with information received from point-of sale or inventory systems operated by the store in order to generate a rich, detailed, and multi-level representation of the products stocked and arranged on the shelves or other displays of the store. The system may further provide one or more user interfaces that facilitate access to and management of product location information. In addition, the system may facilitate product search techniques that provide search results that include specific, store-level, product location information.

Some embodiments provide and utilize a shelf editing collection (“SEC”) smart location device. Typically, the SEC smart location device is identified with a scanner, operated by a user who is engaging the SEC smart location device on a shelf and item identifiers are sent through the network to an inventory location system and/or other system for maintaining/collection location information. Part of the data and one function of the SEC smart location device is called a “location identifier,” “location indicator,” “shelf identifier,” “shelf indicator,” or the like. The SEC smart location device typically is or includes a machine-readable indicator, such as a bar code, RFID tag, or the like, that provides information about a physical store location, including one or more of aisle, side, section, shelf, or the like. The SEC smart location device may be used with any of the embodiments described herein, possibly combined with other SEC commands or actions that are caused or initiated upon scanning an SEC device.

In one embodiment, a digital device receives an initial SEC indication position in a store, the initial device communication with the digital network, or service, is programmed to perform several actions from (1) identifying the exact shelf space, (2) clearing that shelf space and (3) enabling the service to collect items on the shelf with the next activity and (4) automatically assign the item's shelf position or order while it is collected. One embodiment of the SEC smart location device includes the action taken at (1) the beginning of the collection process on a shelf using the previous SEC smart location device, (2) one used at the end of the SEC process, or (3) a new SEC smart location device located on a different shelf, anywhere in the location. One embodiment includes a SEC technique for saving a shelf product's information while enabling continued SEC actions by engaging a new SEC smart location device on another shelf thereby automatically ending the last collection while preparing the new SEC location for a repeat of the collection process on a shelf.

The described techniques advantageously reduce the number and/or kind of user interactions or inputs required during a collection or editing process. In particular, to scan a shelf, the user of the scanner need only scan a first SEC smart location device (typically located at one end of the shelf). This first scan initializes location information (e.g., aisle, side, section, shelf). Then, the user proceeds to scan each of the items on the shelf. Completion of a shelf scan may be signaled in various ways. In one embodiment, the shelf may include a second SEC smart location device at the other end of the shelf, although scanning the original SEC device on the shelf will provide the same function. Only one SEC device is needed on a given shelf in some embodiments. The user may scan the SEC smart location device, anywhere on that shelf where products were scanned and collected, to signal completion. In another embodiment, the user simply scans an SEC smart location device located at the beginning of the next shelf (anywhere at that location) to be scanned. Some embodiments may integrate information from other sources and/or sensors on the scanner. For example, if the scanner includes an accelerometer, the direction (e.g., left to right, or right to left) of a scan may be automatically determined.

### 1(A). Product Location Information Management in a First Embodiment

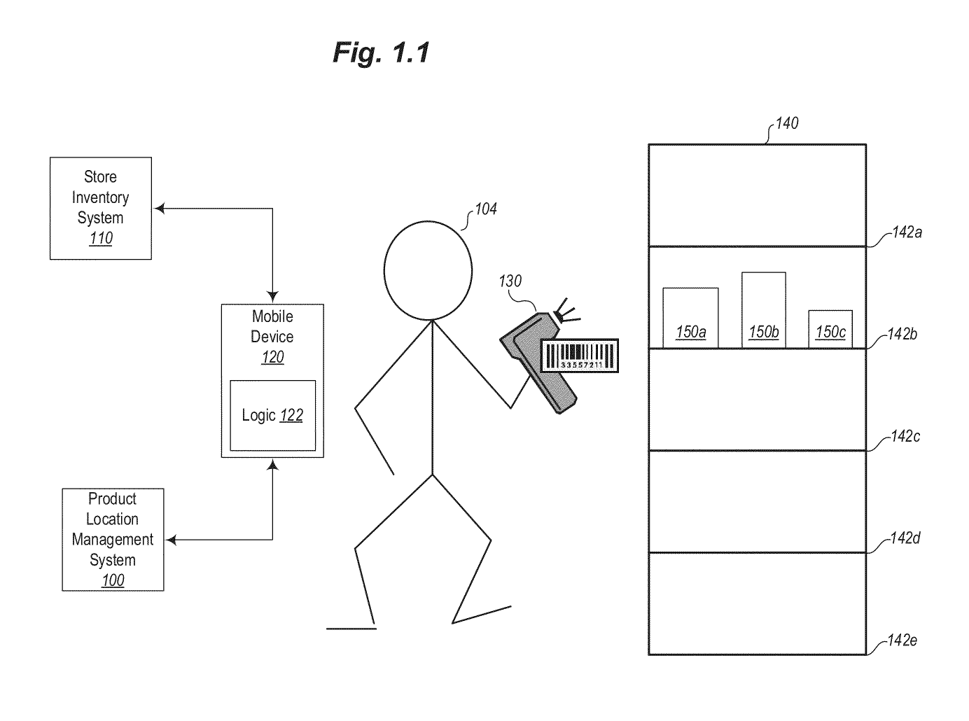

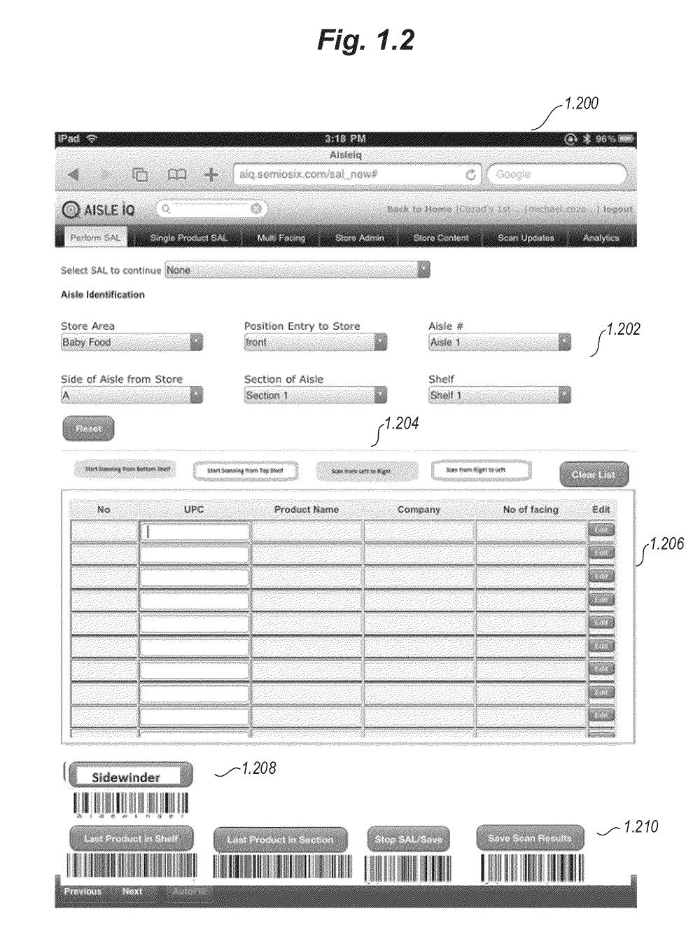

FIG. 1.1 is an example block diagram illustrating product location information management according to an example embodiment. In particular, FIG. 1.1 shows a user 104 operating a scanning device 130 in cooperation with a mobile device 120 to obtain store aisle location (“SAL”) information for items 150a-150c. The items 150 are arranged within a shelving unit 140 comprising shelves 142a-142e. In particular, the items 150 are located on shelf 142b. The mobile device 120 includes logic 122 which may be an application or other module that is configured to facilitate the efficient collection of SAL information, as discussed herein.

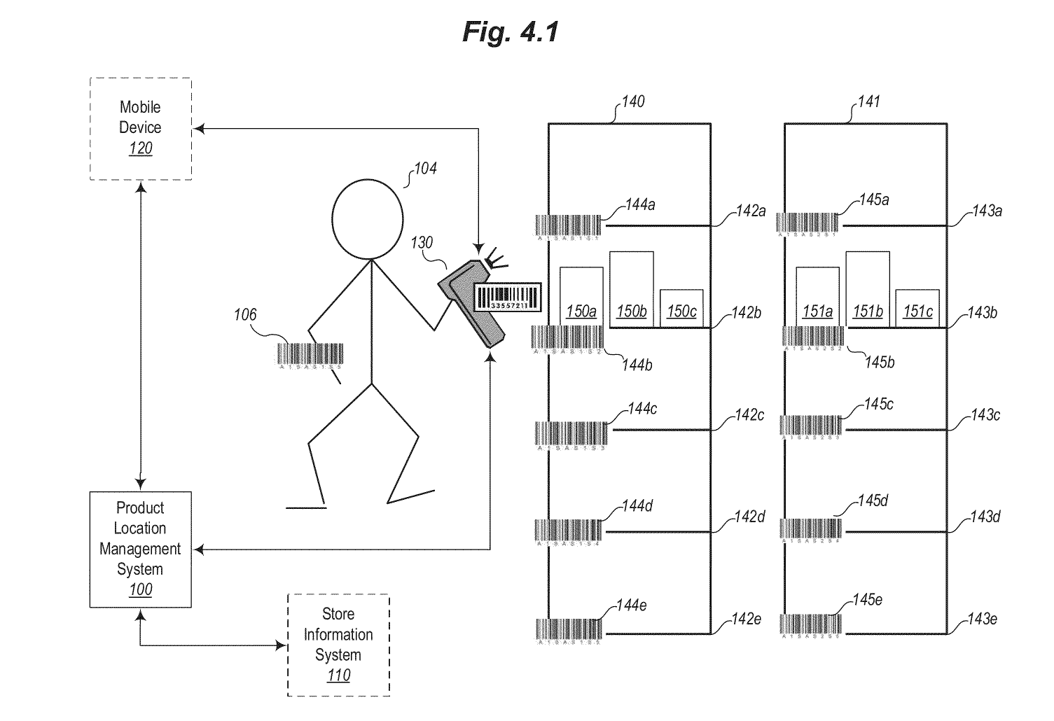

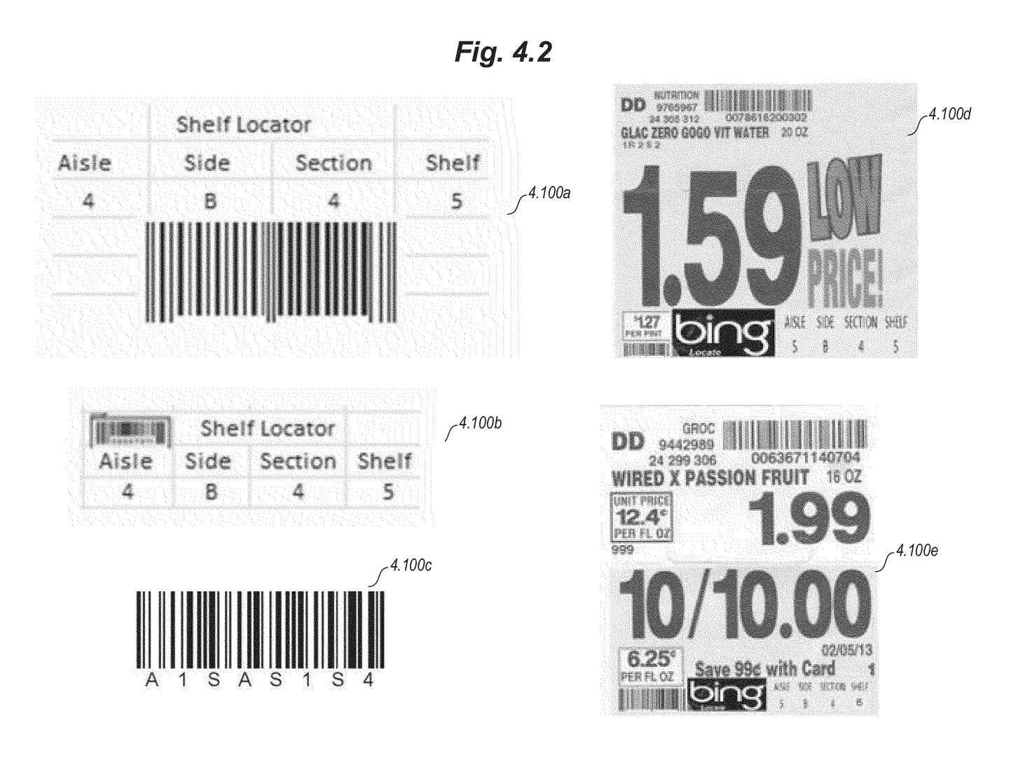

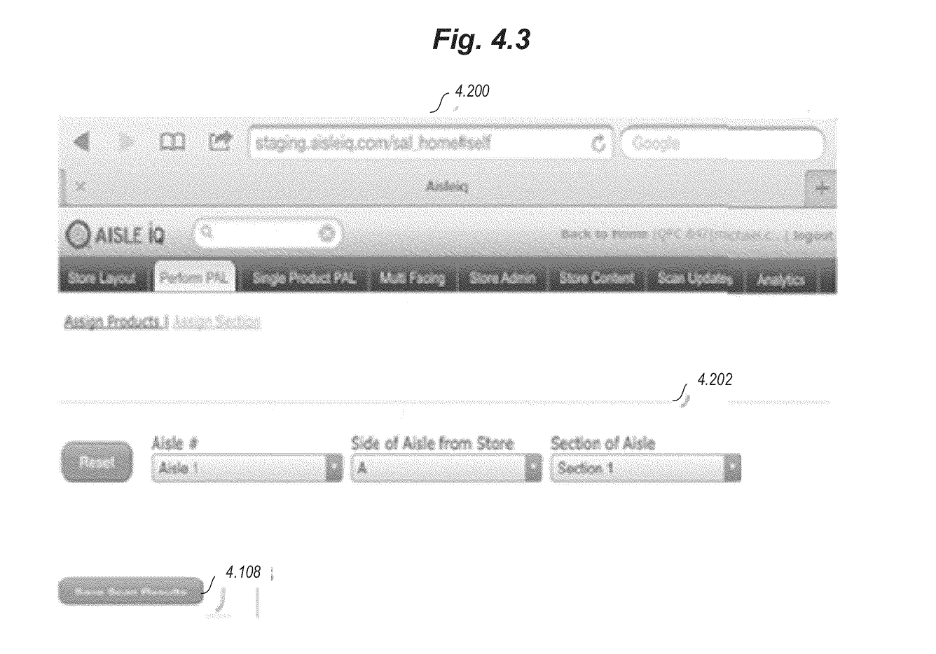

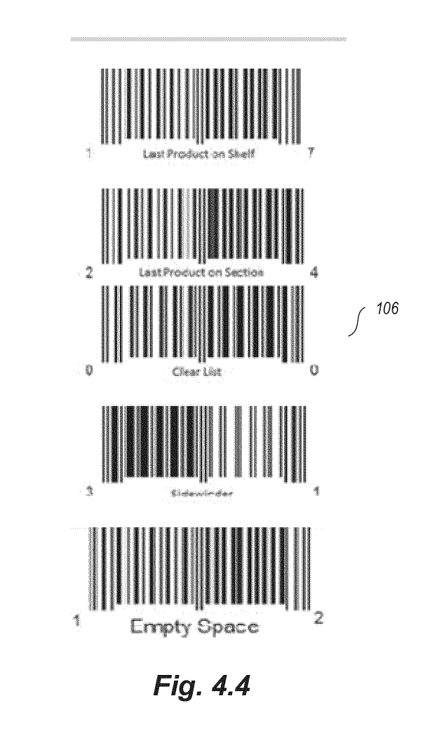

Beginning, in this example, at the left side of shelf 142b, the user 104 specifies an initial position to the logic 122, such as by providing an indication of an aisle, a section, a shelf number, and the like. Then, the user 104 traverses the shelf 142b from left to right, scanning each item 150 in turn with the scanner 130. As each item is scanned (e.g., its barcode is read), the logic 122 records its position with respect to the shelf 142b and other items. In some embodiments, the logic 122 records SAL information corresponding to each scanned item as the items are scanned, such as by interacting with the SAL management system 100 (e.g., via Ajax or some other interaction mechanism). Once the user 104 reaches the right end of the shelf 142b, he indicates such to the logic 122. In some embodiments, the user may scan a command encoded in a wrist band 106 (FIGS. 4.1 and 4.4). In response to the received indication, the logic 122 may automatically transmit the collected information to a store inventory system 110 and/or a SAL management system 100. The user 104 may then advance directionally to scan a next shelf (e.g., 142a or 142c) without making any additional inputs to any mobile device or the logic 122, as the logic 122 can be configured to understand that an adjacent shelf is being scanned. Note that in some embodiments, the user 104 may scan an entire section of shelves without making any inputs to the mobile device or the logic 122 as the user transitions from one shelf to another. In particular, the logic 122 may reference an accelerometer to track the movements of the user 104 and to understand when the user 104 has transitioned from one shelf to another.

The store inventory system 110 may be a point-of-sale system, a back office information system, a tracking system, a database, or the like. Typically, the store inventory system 110 is located on or near the store premises, although it may also or instead be located remotely. The store inventory system 110 will generally have its own format for storing SAL information, and the logic 122 may be configured to translate SAL information from one format (e.g., in which it is represented by the logic 122) to another format (e.g., in which it is represented by the store inventory system 110).

The SAL management system 100 is a companion system to the logic 122 and may provide various services for the logic 122 and/or other clients. For example, the management system 100 may provide redundant storage capabilities for the mobile device 120. As another example, the management system 100 may provide a “virtual” store map based on SAL information collected by the logic 122, so that the user 104 or some other operator can view, updated, and/or modify SAL information for a given store, and then transmit any such changes to the store inventory system 110 or some other location.

FIG. 1.2 is an example user interface screen for a mobile device configured to facilitate collection of store aisle location information according to the first example embodiment. In particular, FIG. 1.2 depicts a user interface screen 1.200 that may be displayed on the mobile device 120 by the logic 122.

The screen 1.200 includes a location identification section 1.202 that includes six controls (e.g., drop-down menus) that can be selected by a user to specify an initial position in the store. The menus include Store Area, Position, Aisle Number, Side of Aisle, Section of Aisle, and Shelf Number.

The screen 1.200 also includes a scan order section 1.204 that includes four controls (e.g., buttons) that can be selected by the user to specify a scanning order, including starting from the bottom shelf in a section, starting from the top shelf in a section, scanning from left to right, and scanning from right to left, which determines a virtual presentation when viewing the product data after the collection activity.

The screen 1.200 further includes a SAL information display section 1.206 that includes a table used to display information about items as they are scanned by the user. The table displays item number, scan or collection order, UPC number, product name, company name, number of facing for that associated product (e.g., facing information).

The screen 1.200 also includes a sidewinder control 1.208 that can be selected by the user to specify a “zig-zag” pattern of scanning, such as scanning a first shelf in a section in a left-to-right fashion, scanning a second adjacent shelf (e.g., above or below the first shelf) in a right-to-left fashion, scanning a third adjacent shelf in a left-to-right fashion and so on. Sidewinder scanning advantageously may reduce the amount of user travel by as much as a half, because the user need not walk back to the same side of the shelf prior to scanning the shelf. Products are represented as they are positioned on the shelf for viewing after the collection is complete.

The screen 1.200 also includes a control section 1.210 that includes controls (e.g., buttons) that can be selected by the user to indicate events or initiate functions during scanning. For example, the user can indicate that the last item in a shelf has been scanned, that the last product in a section has been scanned, that the SAL logic should save the current data, and the like. In response to an indication that a last item has been scanned, the SAL logic may automatically reset the controls (e.g., that specify location) to the next area (shelf/section) being scanned.

Note that many of the buttons on the screen 1.200 have below them corresponding barcode symbols which can also be worn by the user as shown in wrist band 106 in FIGS. 4.1 and 4.4. These barcode symbols can be scanned in lieu of pressing the button, so that the user need not ungrasp the scanner in order to indicate that he has reached the end of a shelf or section. In some embodiments, these bars codes are located on touch screen devices, controls and has built in commands to place the cursor focus in the correct input field to permit item collection without touching the device, thereby saving the user another engagement with the device.

In some scenarios, the user is wearing an arm band 106. The arm band 106 includes one or more bar codes that each encode or identify a particular operation or command to be transmitted from the scanner 130 to the mobile device 120 or the management system 100. Example operations/commands include last product on shelf, last product in section, clear list, sidewinder mode, empty space, save, or the like. For example, the user may scan the sidewinder mode bar code in order to inform the management system 100 and/or the mobile device 120 that he is scanning in a zigzag (e.g., right to left, left to right) manner.

### 1(B). Product Location Information Management in a Second Embodiment

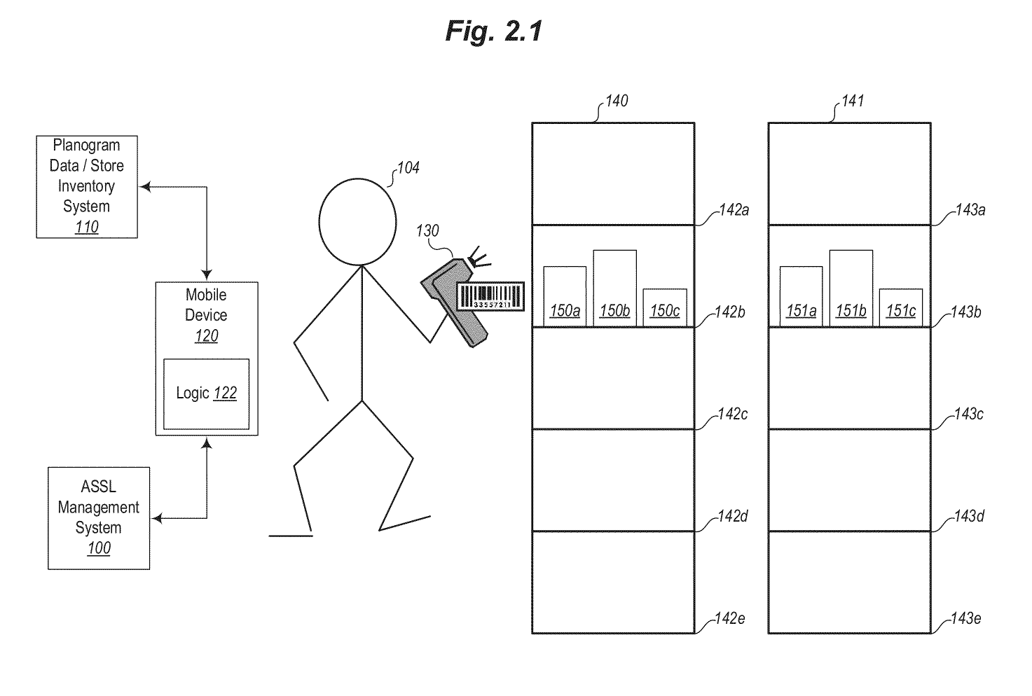

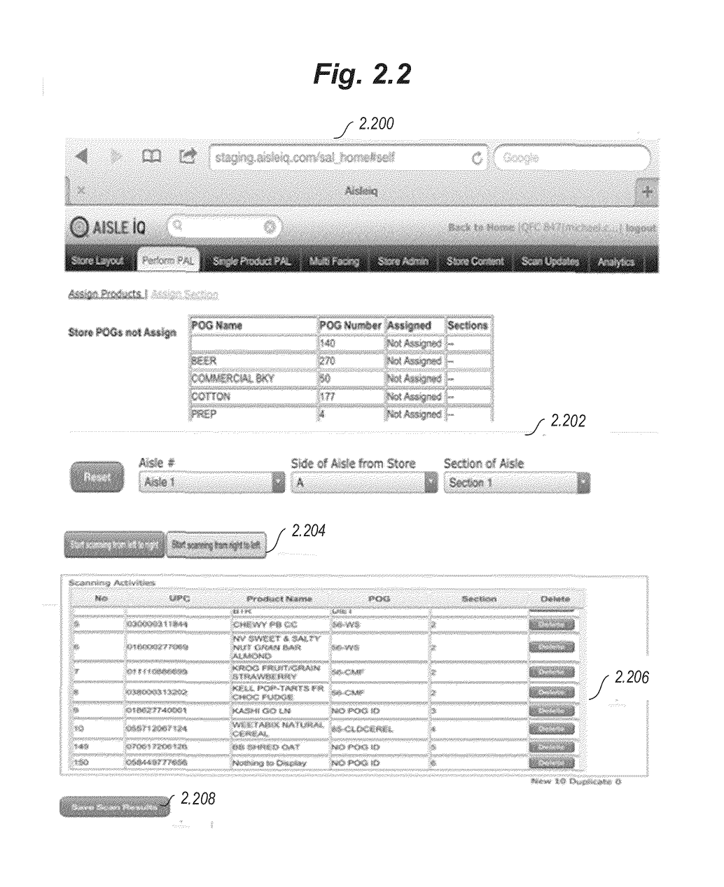

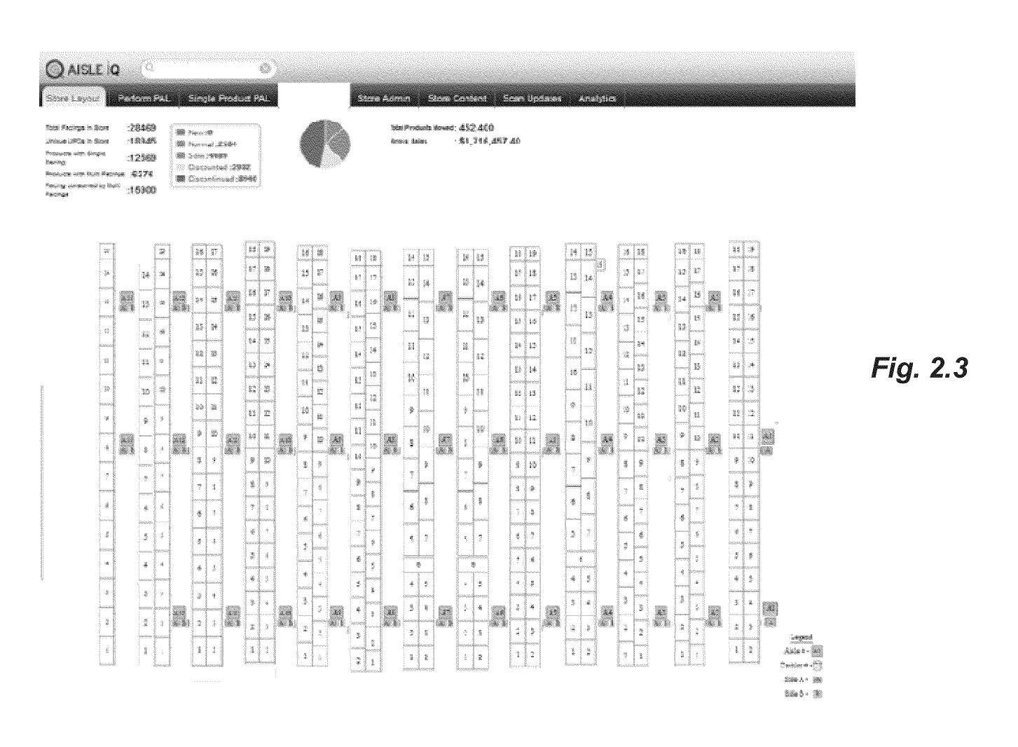

FIG. 2.1 is an example block diagram illustrating product location information management according to a second embodiment. In particular, FIG. 2.1 shows a user 104 operating a scanning device 130 in cooperation with a mobile device 120 to obtain ASSL information for item/section 140 by scanning any one or more of items 150a-150c and then information for item/section 141 by scanning any one or more of items 151a-151c. The items 150 and 151 are arranged within a section unit 140 and 141 comprising shelves 142a-142e and 143a-143e. In particular, the items 150 are located on shelf 142b and located on shelf 143b. The device 120 includes logic 122 which may be an application or other module that is configured to facilitate the efficient collection of ASSL information, as discussed herein.

Beginning, in this example, with any product in 140 or on 142b, the user 104 specifies an initial position to the logic 122, such as by providing an indication of an aisle, a side, a section. Then, the user 104 traverses from 140 to 141, left to right or right to left, scanning a single item 150 in turn with the scanner 130 then scanning a single item 151. As each item is scanned (e.g., its barcode is read, ASSL is generated, stored), the logic 122 records its position with respect to that ASSL location and to other ASSL locations and store data. Once the user 104 reaches the right end of the section 141 he indicates such to the logic 122. In response, the logic 122 may automatically transmit the collected information to a store inventory system 110 and/or a ASSL and or SAL management system 100. In other examples, the logic 122 may transmit the collected information to the systems 100 and/or 110 in an ongoing manner, such as during traversal of the sections 140 and 141. The user 104 may then move to a new aisle/side location and perform the previous steps until the entire location's aisles/sides and sections are collected. After information is collected, it may be presented as shown in a store layout or other graphical representation as shown in FIG. 2.3.

The above-described approach leverages POG data to improve the efficiency of store scanning and to obtain other advantages. Notably, a user can in some cases scan just a single item in a store section, use information from that item to identify the relevant POG, and then obtain location information for all of the remaining items in the store section based on the identified POG. This may reduce the number of items that need to be manually scanned by one or more orders of magnitude (e.g., a factor of 10 or 100). In addition, the described techniques can be used to efficiently generate a store layout map or other graphical representation. In many cases, a given POG may represent the layout of a particular section, but may not be linked to actual physical locations in stores. Thus, it may not be possible, due to variations in store/shelf layout, length, and/or orientation to generate a store layout or map based on POGs alone. However, once POG data is combined with real location information obtained by in-store scanning, a store layout can be efficiently generated, without the overhead of scanning every single item in the store.

In addition, the techniques can be used to correct POGs or store data. For example, a particular POG may indicate 10 products on a given shelf, while a physical store may only stock 9 products on that shelf. After scanning an item on the shelf and locating the corresponding POG, the logic 122 may populate a user interface of the device 120 with the products listed in the POG. The user may then compare these 10 products to the items on the actual shelf, noticing that the actual shelf only contains 9 products. Then, the user can correct the POG by selecting the missing product via the user interface. In response to the selection, the logic 122 may modify the POG and/or any other data records that are incorrect or otherwise inconsistent with the actual layout of store products.

The techniques may also be used when products are added or removed from store shelves. When a new product is added to a section, the user may simply scan an item adjacent to the location for the new product (thereby identifying the section, shelf, and position), and then scan the new product. In response, the logic 122 will automatically adjust any stored information, including ASSL, POGs, or store data to reflect the new item. Without these techniques, whenever products are added or removed from a store location, a user may have to manually adjust multiple different data sets, including inventory data, point of sale data, the POG, and any other representation of product location.

The store inventory system 110 may be a point-of-sale system, a back office information system, a tracking system, a database, or the like. Typically, the store inventory system 110 is located on or near the store premises, although it may also or instead be located remotely. The store inventory system 110 will generally have its own format for storing ASSL information, planogram data (POGs) and the logic 122 may be configured to translate ASSL information from one format (e.g., in which it is represented by the logic 122) to another format (e.g., in which it is represented by the store inventory system 110).

The ASSL management system 100 is a companion system to the logic 122 and may provide various services for the logic 122 and/or other clients. For example, the management system 100 may provide redundant storage capabilities for the mobile device 120. As another example, the management system 100 may provide a “virtual” store map (e.g., FIG. 2.3) based on ASSL information collected by the logic 122, so that the user 104 or some other operator can view, updated, and/or modify ASSL information for a given store, and then transmit any such changes to the store inventory system 110 or some other location. System 100 is designed work in conjunction with shelf item management.

FIG. 2.2 is an example user interface screen for a mobile device configured to facilitate collection of store aisle location information according to the second example embodiment. In particular, FIG. 2.2 depicts a user interface screen 2.200 that may be displayed on the mobile device 120 by the logic 122.

The screen 2.200 includes a location identification section 2.202 that includes 3 controls, (e.g., drop-down menus) that can be selected by a user to specify an initial position in the store. The menus include Aisle Number, Side of Aisle, and Section of Aisle to start from.

The screen 2.200 also includes a scan order section 2.204 that includes two controls (e.g., buttons) that can be selected by the user to specify a scanning order, including starting scanning from left to right, and or scanning from right to left.

The screen 2.200 further includes an ASSL information display section 2.206 that includes a table used to display information about items as they are scanned by the user. The table displays item scanned, UPC number, product name, Store POG if that product was located anywhere in the POG, and Section generation number information and a Delete Button for mistakes made during the collection exercise.

The screen 2.200 further includes a control 2.208 (e.g., button) that can be selected by the user to indicate an event is over and save the ASSL file to System 100. Note that in some embodiments, one or more of the controls (e.g., buttons) may have a corresponding barcode symbol. These barcode symbols can be scanned in lieu of pressing the button, so that the user need not ungrasp the scanner in order to indicate, for example, that the end of a section is reached or that data is to be saved.

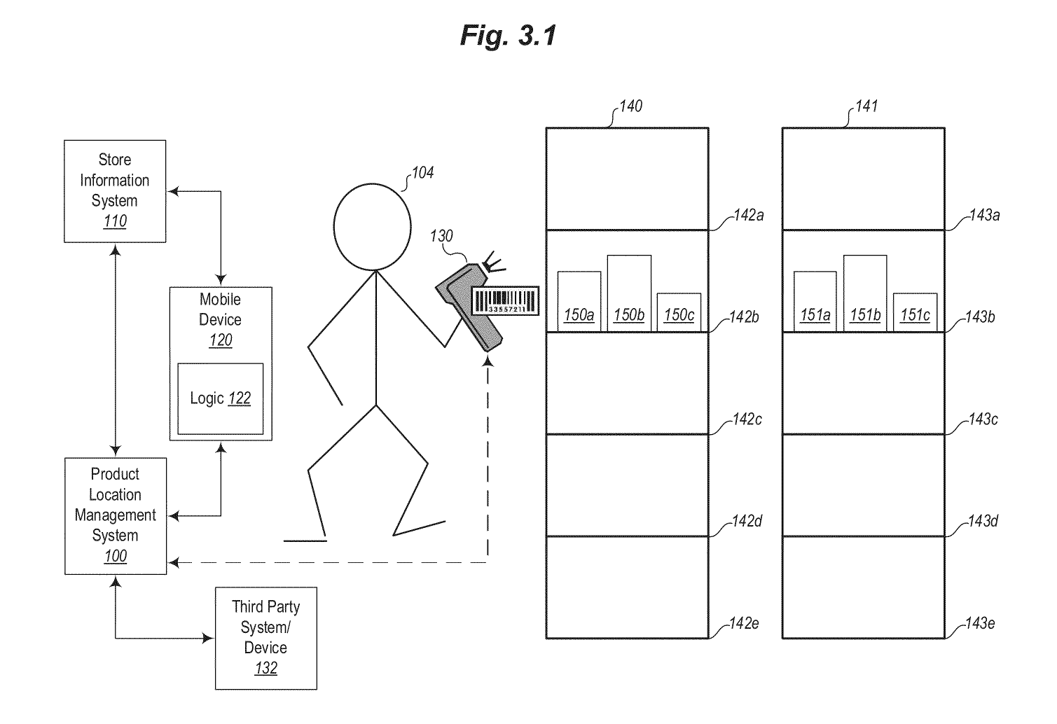

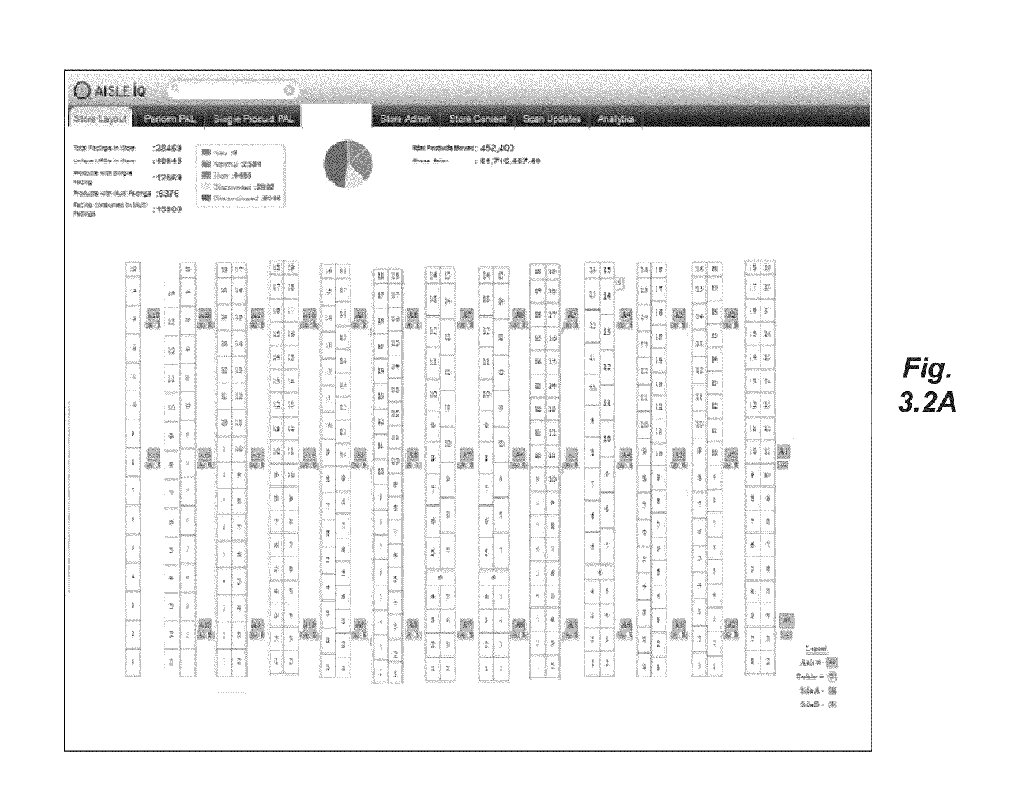

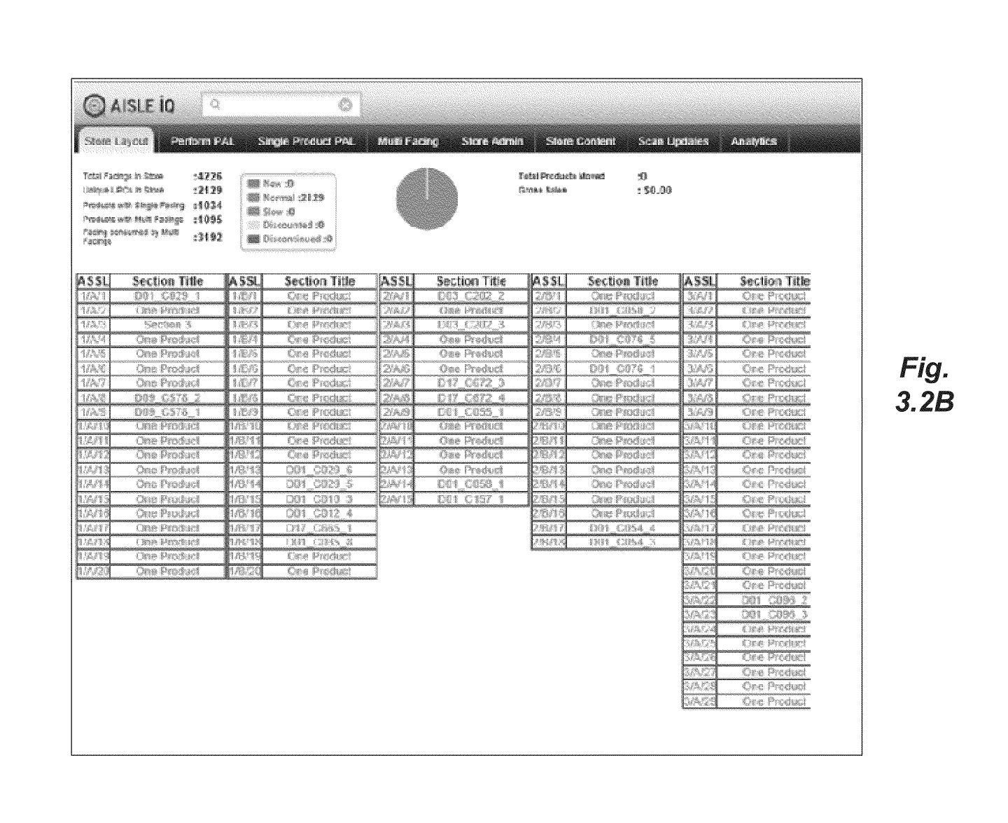

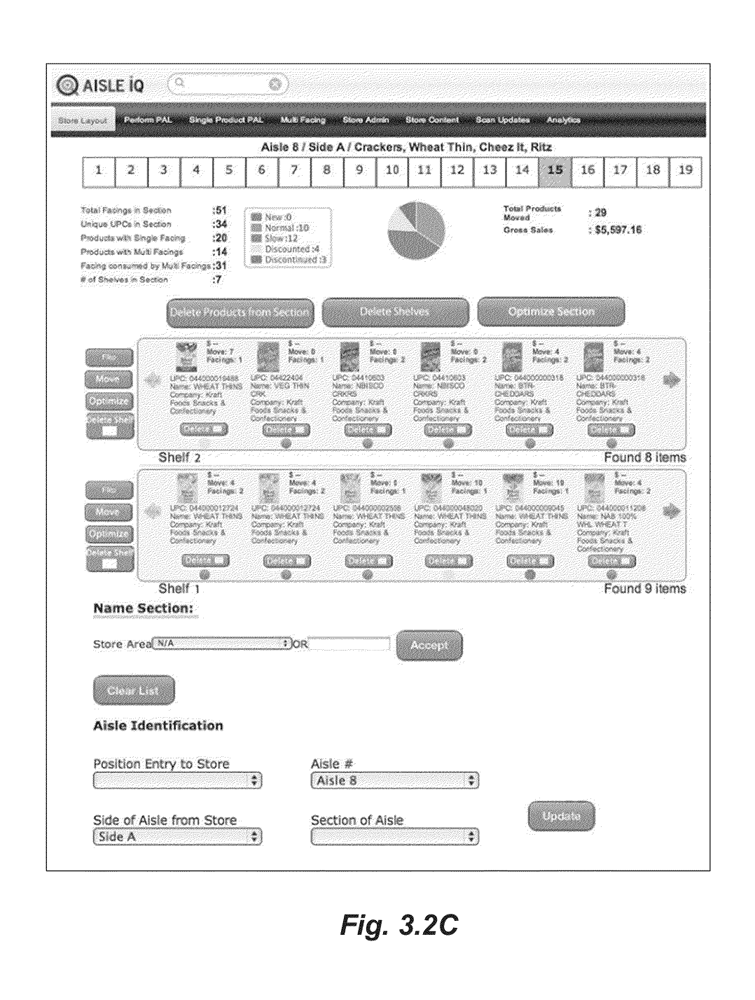

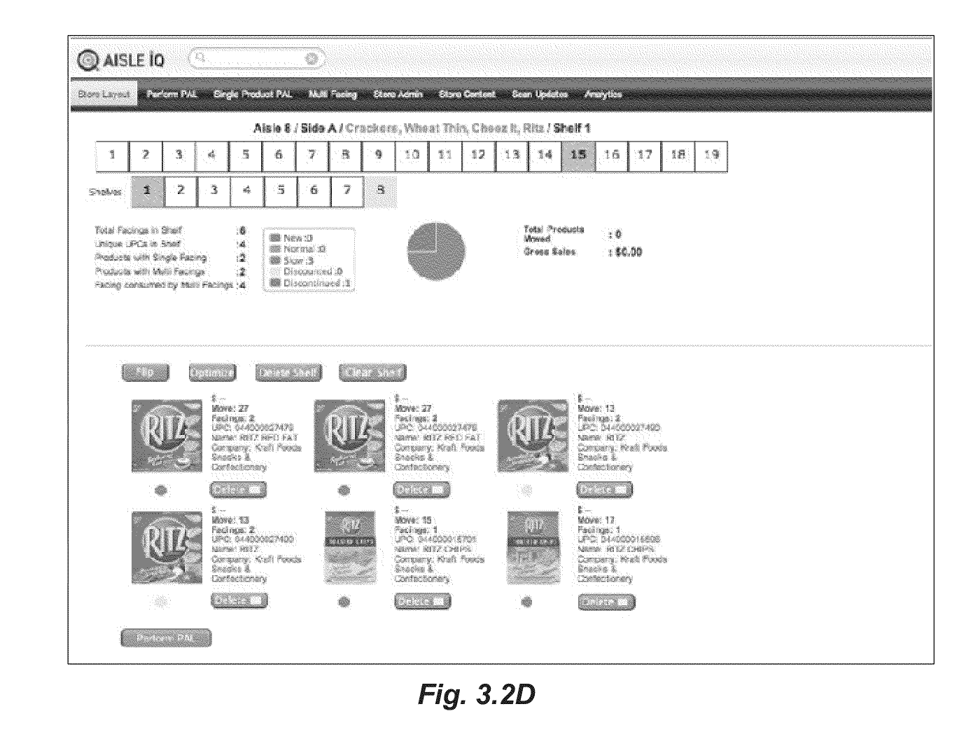

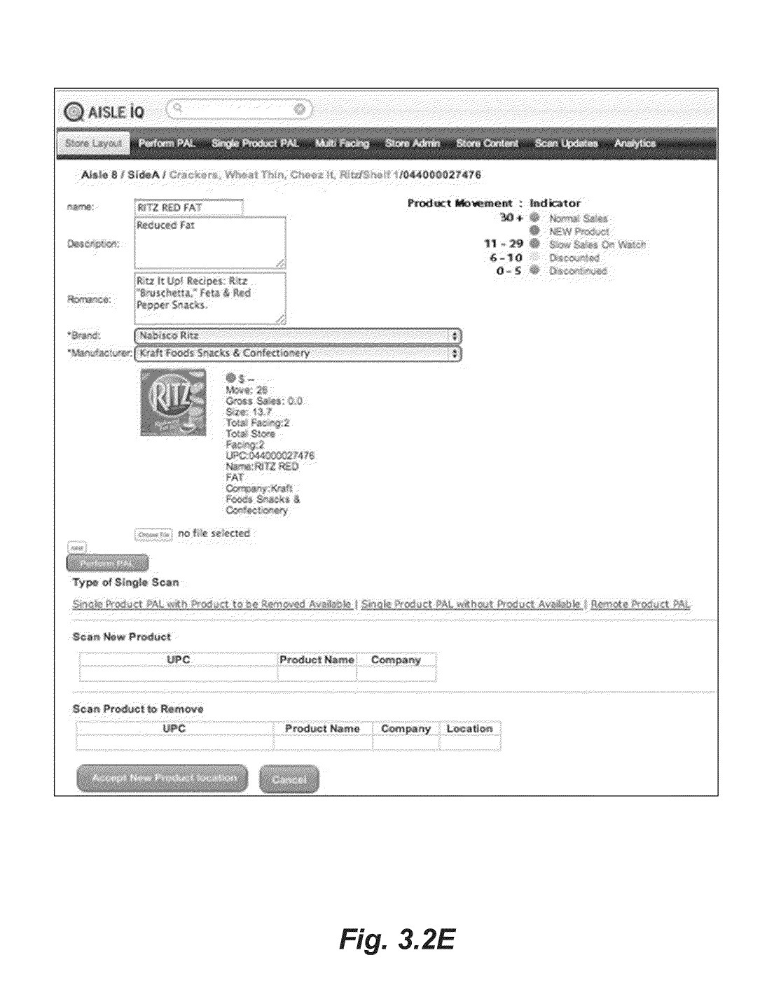

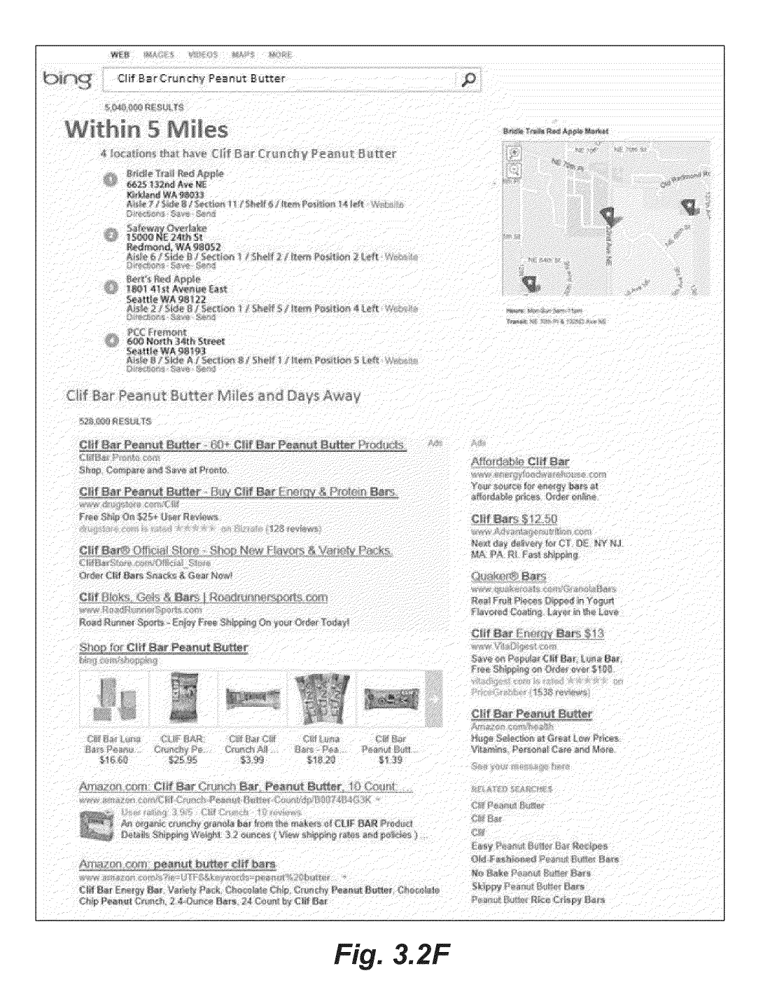

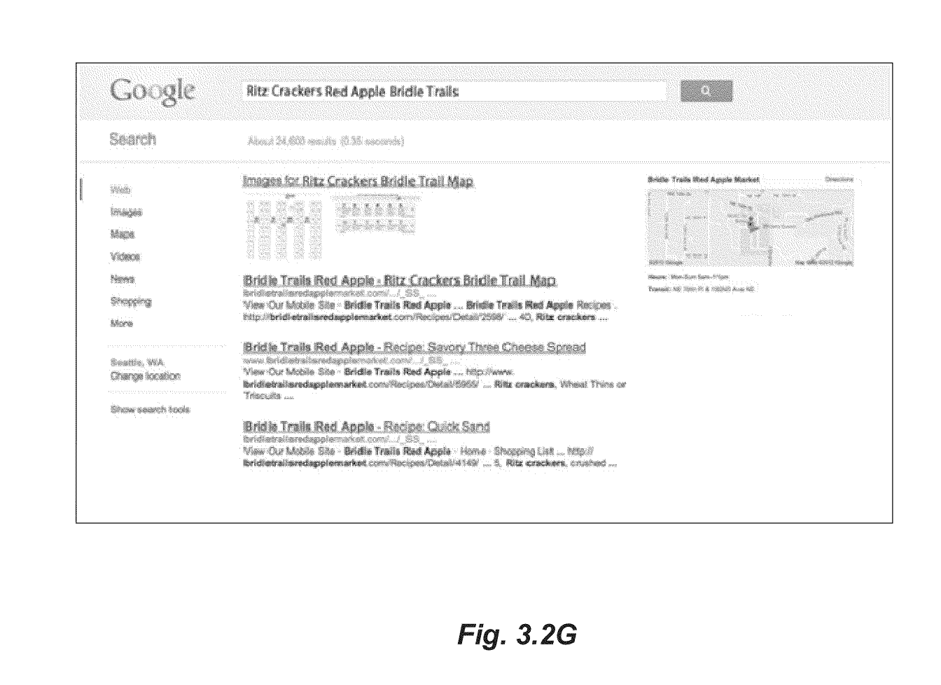

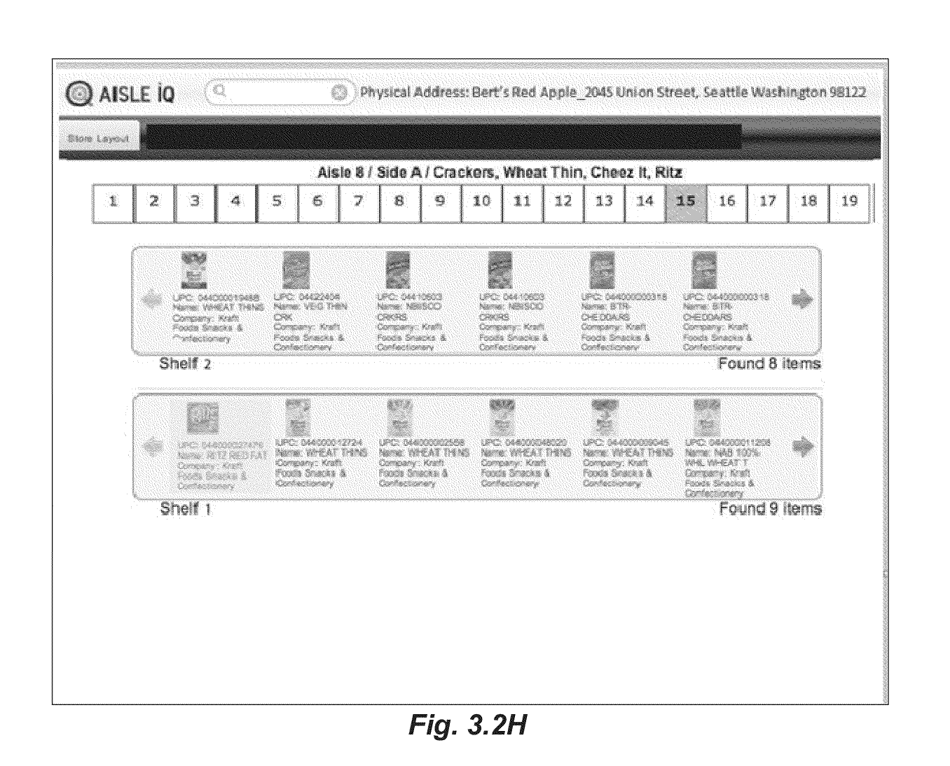

FIG. 2.3 is an example store layout (e.g., map) generated by the second example embodiment. Additional details related to store maps and other layouts are provided with respect to FIGS. 3.2A-3.2E, below.

### 1(C). Product Location Information Management in a Third Embodiment

FIG. 3.1 is an example block diagram illustrating product location information management according to a third example embodiment. Product location information management includes collecting, storing, generating, and synthesizing information about the location of products in a retail location. Product location information may also include generating maps or other visual representations of location information obtained via data collection activities.

FIG. 3.1 shows a user 104 operating a scanning device 130 in cooperation with a mobile (client) device 120 (or by passing information directly to system 100) to obtain product location information (e.g., aisle, section, side, location, position) for section 140 by scanning any one or more of items 150a-150c and then information for item/section 141 by scanning any one or more of items 151a-151c. The items 150 and 151 are arranged within section units 140 and 141 respectively comprising shelves 142a-142e and 143a-143e. In particular, the items 150 are located on shelf 142b and located on shelf 143b. The device 120 (or system 100) includes logic 122 which may be an application or other module that is configured to facilitate the efficient collection of product location information, as discussed herein.

Upon, during, or after the scanning operation, the logic 122 of the client device 120 records and/or transmits product location information to a product location management system 100. In some cases, location information may be communicated in different ways such as directly from the scanner 130 to the system 100, when communication is not intermediated by the logic 122 or the client device 120. The system 100 and/or the client device 120 may also use information received from a store information system 110. The store information system 110 may be an inventory system, a point-of-sale system, a back office information system, a tracking system, a database, or the like. Typically, the store information system 110 is located on or near the store premises, although it may also or instead be located remotely. The store information system 110 will generally have its own format for storing product location information, planogram (“POG”) data. The logic 122 may be configured to translate product location information from one format (e.g., in which it is represented by the logic 122 or the system 100) to another format (e.g., in which it is represented by the store information system 110).

The logic 122 may also exploit information received from the system 110 to improve the efficiency of the data collection operation. For example, POG data provided by the system 110 may be used to improve the efficiency of store scanning and to obtain other advantages. Notably, the user 104 can scan just a single item in a store aisle side section, use information from that item to identify the relevant POG (e.g., any PGO(s) supplied by system 110 that include the item) that represents the section, and then obtain location information for all of the remaining items in the store section based on the identified POG. This will reduce the number of items that need to be manually scanned by one or more orders of magnitude (e.g., a factor of 10 or 100).

In addition, the described techniques can be used to efficiently generate a store layout map or other graphical representation. In many cases, a given POG may represent the layout of a particular section, but may not be linked to actual physical locations in stores. Thus, it may not be possible, due to variations in store/shelf layout, length, and/or orientation to generate a store layout or map based on POGs alone. However, once POG data is combined with real location information obtained by in-store scanning, a store layout can be efficiently generated, without the overhead of scanning every single item in the store.

The product location management system 100 is a companion system to the logic 122 and may provide various services for the logic 122 and/or other clients. Some or all of the logic 122 can be in the system 100 or the scanner 130 or some other device, rather than in the mobile device 120. For example, the management system 100 may provide redundant storage capabilities for the mobile device 120. As another example, the management system 100 may provide a “virtual” store map based on location information collected by the logic 122, so that the user 104 or some other operator can view, updated, and/or modify product information for a given store, and then transmit any such changes to the store information system 110 or some other location. Example user interfaces for product location information management are shown and described with respect to FIGS. 3.2A-3.2E.

The management system 100 may also provide a search facility. In some embodiments, the system 100 may provide information to search services (e.g., Google, Bing) that execute as a third-party system 132. The management system 100 may receive product location information as well as sales information from multiple stores. Using this information received from stores, the management system 100 may track the presence/absence of products in stores in addition to the exact location of such products down to the aisle, side, section, shelf, and position level. Then, the product location information may be provided in response to search requests received directly from client devices or indirectly via a third-party search service on one of the systems 132.

In some embodiments, search results may be based at least in part on what locations are near the present location of a user. For example, search results may include results or suggestions (possibly based on paid placement) for products that are known to be within reach or otherwise very nearby a user's current location. The user's current location may be learned in various ways, such as via a GPS in the user's mobile computing device or based on a bar code scanned by the user at the store (e.g., to obtain dietary or price information regarding a product on a shelf).

FIGS. 3.2A-3.2H depict example user interface screens for product location information management and search according to the third example embodiment. The user interface screens may be displayed by the mobile device 120 and/or some other client device/system. The user interface screens may be provided by the product location management system 100 for display on a client device/system. In other embodiments, the user interface screens may be displayed as part of a standalone executable running on a desktop or other computing system or device.

FIGS. 3.2A-3.2E depict store navigation and product location information management user interface screens that are automatically generated by scanning according to one embodiment. By way of overview, FIGS. 3.2A and 3.2B depict example store layouts generated and presented by example embodiments. FIGS. 3.2C-3.2E depict example user interface screens configured to facilitate product location management at a finer-grained level, such as at the section, shelf, or item level.

FIG. 3.2A depicts a “map” style layout that provides a graphical view of store aisles and sections. In contrast, FIG. 3.2B is a tabular layout that provides a textual view of store aisles and sections. Either or both of the illustrated layouts may be interactive, in that a user can select (e.g., click, touch) a portion of the layout (e.g., an aisle or section) in order to access a user interface configured to provide a more detailed level of navigation or browsing, such as an aisle, section, or shelf-level browser/navigator user interface described with respect to FIGS. 3.2C or 3.2D, below. The map of FIG. 3.2A and the tabular layout of FIG. 3.2B are in this embodiment generated by scanning activities only, and does not require a human to draw or lay out a map or other representation.

FIG. 3.2C depicts an aisle/section-level navigation user interface. The illustrated user interface depicts the sections of a single aisle. Upon user selection of one of the sections, shelf information is dynamically presented. The user interface also provides quantity information related to the selected section, such as the total number of facings, unique UPCs, number of single/multiple facings, and the like.

The user interface further provides color-coded movement information. The movement information can be used by a store manager to determine the sales effectiveness of particular products and/or their arrangements. The movement information identifies (numerically and by way of pie chart) how many products are new, moving normally, moving slowly, discounted, and discontinued. Total sales information for the selected section is also presented.

In this example, blue is used to indicate new products (e.g., for which there is insufficient data to make a determination), green is used to indicate normal products, brown is used to indicate slow products, yellow is used to indicate discounted products, and red is used to indicate discontinued products. What is considered “normal” or “slow” may be based on human specified ranges (e.g., between 10 and 30 units per month) and/or automatically determined ranges, such as within one standard deviation of an average (e.g., average of other products in the same product category, other products in the same or different stores, etc.). In some embodiments, a “heat map” of a section, aisle, or entire store may be generated, in order to graphically depict areas or regions of a store that are particularly high (e.g., colored red to indicate “hot”) or low (e.g., colored “blue” to indicate “cold”) revenue generators.

The user interface further includes controls for managing product information, such as by deleting products from the section, deleting shelves from the section, or optimizing the section. Optimizing the section may include automatically rearranging, adding, or removing products to improve the sales prospects for the section. For example, poor performing products may be moved to lower shelves or removed altogether.

The user interface also presents a section name, which may be manually entered or automatically determined. Automatically determining a section name may be based on the most frequently occurring product or product category in the section. Other approaches may include machine learning/classification, such as by using a Bayesian classifier or neural network to classify a section based on the products located there.

FIG. 3.2D depicts a shelf-level navigation user interface that is in this embodiment automatically generated based on scanning activities only. The shelf-level navigation user interface may be presented in response to a user selection of a particular section or shelf in the user interface of FIG. 3.2C, above. The shelf-level navigation user interface includes at least some elements that are analogous to those described with respect to FIG. 3.2C, such as per-shelf movement information, quantity information, management controls, and the like.

FIG. 3.2E depicts a product-level navigation user interface that is in this embodiment automatically generated based on scanning activities only. The product-level navigation user interface may be presented in response to a user selection of a particular shelf or product in the user interface of FIG. 3.2D, above. The product-level navigation user interface includes at least some elements that are analogous to those described with respect to FIGS. 3.2C and 3.2D, such as per-product movement information, quantity information, management controls, and the like.

FIGS. 3.2F-3.2H depict product search user interface screens according to example embodiments. In FIG. 3.2F, a user has provided a search query of “Clif Bar Crunchy Peanut Butter.” In response, the product location management system 100 provides search results that include specific product location information including, for each store that has the product in stock, the aisle, side, section, shelf, and position of the product. The product location information provided here is in textual form. The illustrated search results are based at least in part on in-store scanning activities.

FIG. 3.2G depicts another example search (in the context of a different search service), in which the search results include product location information in graphical form. The product location information shown with respect to FIGS. 3.2F and 3.2G may be interactive, such that when a user selects the information, a navigator user interface may be presented to the user, such as is described with respect to FIG. 3.2H.

FIG. 3.2H depicts an aisle/section-level navigation user interface that is in this embodiment automatically generated based on scanning activities only. The illustrated user interface is similar to the one shown and described with respect to FIG. 3.2C, above. In typical embodiments, the interface of FIG. 3.2H will not include management controls and/or movement information, because such controls or information would typically be restricted to owners, managers, or employees of a particular store. Using the illustrated interface, a consumer can obtain a view of the product in context with other nearby products.

### 1(D). Product Location Information Management in a Fourth Embodiment

FIG. 4.1 is an example block diagram illustrating product location information management according to a fourth example embodiment. In particular, FIG. 4.1 shows a user 104, operating a scanning device 130, in cooperation with management system 100 and/or with an optional mobile device 120 to obtain and/or edit location information about items located in aisle sections 140 and/or 141. Sections 140 and 141 respectively include items 150a-150c and 151a-151c arranged on shelves 142a-142e and 143a-143e. Each of the shelves 142a-142e and 143a-143e has an attached corresponding location device 144a-144e and 145a-145e. The location devices 144a-144e and 145a-145e are examples of the SEC smart location devices. In this example embodiment, the location devices are bar code labels physically attached to shelves. Other types of smart location devices may be used, such as RFID tags.

In this example, the user 130 wishes to scan items 150a-150c on shelf 142b. To initiate the scan, the user 130 scans device 144b, thereby obtaining location information corresponding to shelf 142b, including one or more of aisle, side, section, shelf, shelf end, or the like. The information may be encoded directly on the device 144b or obtained indirectly, such as based on an identifier encoded on the device 144b, the identifier used to look up the location information in the management system 100, the store information system 110, and/or the mobile device 120.

Upon scanning the device 144b (or some other similar location device), one or more of the following operations are automatically performed by one or more of the scanner 130, the device 120, the management system 110:
1. Activate the SEC Smart device
2. Identify 142b location
3. Clear/remove/delete 142b of items
4. Set the product counter to zero
5. Enable user 104 to use 130 to immediately (without additional user inputs) collect item shelf location data traversing from 150a-150c.
6. When the end of shelf 142b is reached, the user 104 scans another location device (not shown) attached to the end of shelf 142b in order to signal completion of the shelf 142b. Alternatively, the user may signal completion by rescanning the device 144b or some other device 144 or 145.
7. If the user scans a new device 144 or 145, one or more of the following operations are performed:
   a) Saves the item location information for the previous shelf scanned (142b)
   b) Identify corresponding shelf/location 142 or 143
   c) Clear/remove/delete location information for items on 142 or 143
   d) Set the product counter to zero
   e) Enable 104 to use 130 to immediately collect item shelf location data traversing from one end of the shelf to the other, or the end of the shelf 144 or 145 are hung on, to display products correctly right to left or left to right. Ideally 144 or 145 are hung on the end where 150a is positioned.
   f) At the end of 142 or 143, 104 can either,
   g) Rescanning the exact 144 or 145 just scanned to save and stop continues SEC Smart location use
   h) Scan a new 144 or 145 device, and repeat actions until 104 is done using the SEC smart locator.

In this example, the user is wearing an arm band 106. The arm band 106 includes one or more bar codes that each encode or identify a particular operation or command to be transmitted from the scanner 130 to the mobile device 120 or the management system 100. Example operations/commands include last product on shelf, last product in section, clear list, sidewinder mode, empty space, save, or the like. For example, the user may scan the sidewinder mode bar code in order to inform the management system 100 and/or the mobile device 120 that he is scanning in a zigzag (e.g., right to left, left to right) manner.

FIG. 4.2 is an example of the SEC smart location device configured to facilitate collection of product aisle location information according to the fourth example embodiment. FIG. 4.2 shows five example location devices 4.100a-e. As noted, the devices may be physically attached to shelves (like a price tag). In other embodiments, they may be incorporated into a price strip (a continuous strip of tags attached to a shelf), attached to a wall adjacent to a shelf, incorporated into one or more price tags, or the like.

In some embodiments, each shelf includes at least one location device 4.100, such as one attached to the left or right end of the shelf. Other embodiments use a first location device 4.100 attached to a first shelf end (e.g., the left end) and a second location device 4.100 attached to a second shelf end (e.g., the right end). Some embodiments, use only a single location device 4.100 per aisle, side, and/or section.

Scanning a location device 4.100 may also initiate an auditing function, such that the management system 100 may track the number and utilization of the smart location devices. The number and utilization of smart location devices may be tracked for licensing purposes, for system monitoring, or the like.

In some embodiments, such as when a store has never been scanned before, the user may first walk the store in order to create a “skeleton” or placeholder map. The user walks the store, recording the number of aisles, sides, sections, and/or shelves. These parameters may be entered via the mobile device 120, speech recognition, or other input mechanism. Upon entering these parameters, the management system 100 may create a skeleton map as well as any associated data structures (e.g., database tables). The system 100 may further generate smart location tags/devices, which are then printed and attached to the corresponding locations in the store. Once the store has been instrumented with smart location devices, the user may efficiently scan the products located on the store shelves as described herein.

FIG. 4.3 is an example user interface screen for a mobile device configured to facilitate collection of store aisle location information according to the fourth example embodiment. In particular, FIG. 4.3 depicts a user interface screen 4.200 that may be displayed on the mobile device 120 by the logic 122. This device can generate a map without scanning by setting the aisle side section menus to the number of sections on an aisle side which will generate a store map without scanning any items. This will generate a store layout map without any items on any shelves by selecting “save” for each aisle side.

The screen 4.200 includes a location identification section 4.202 that includes 3 controls, (e.g., drop-down menus) that can be selected by a user to specify an initial position in the store. The menus include Aisle Number, Side of Aisle, and Section of Aisle to start from. In typical embodiments, the user need not manually operate these controls. Rather, the user simply scans a smart location device (e.g., bar code) that stores or otherwise identifies the aisle, side, and section. Having obtained the initial aisle, side, section, the logic 122 can automatically set these controls to display the location being scanned.

The screen 2.200 further includes a control 2.208 (e.g., button) that can be selected by the user to indicate an event is over and save the ASSL file to System 100. Note that in some embodiments, one or more of the controls (e.g., buttons) may have a corresponding barcode symbol. These barcode symbols can be scanned in lieu of pressing the button, so that the user need not ungrasp the scanner in order to indicate, for example, that the end of a section is reached or that data is to be saved. Also, in some embodiments, the information may automatically be saved when the next smart location device is scanned.

FIG. 4.4 is an example command strip configured to facilitate collection of product location information in example embodiments. More specifically, FIG. 4.4 shows an arm band 106 that includes five bar codes that each encode a corresponding command identifier, including last item on shelf, last item in section, clear list, sidewinder mode, and empty space. By scanning one of these bar codes, the user can cause the management system 100 to save a shelf or section worth of location information, enter/leave sidewinder mode, signal an empty space on a shelf, or the like. Other embodiments may include a greater or lesser number of commands. In addition, the command strip need not be worn—rather, it may be located on or about the mobile device 120, a cart or tray, or other object. Although the band 106 is described with respect to the fourth example embodiment, it can be equally employed in other embodiments, including the first, second, and third, above.

Note that the techniques described herein are not limited to data collection in a retail environment. For example, at least some of the techniques may be employed in the context of a library or warehouse environment. In general, they may be applicable to data collection with respect to any ordered arrangement of items. In addition, although four example embodiments have been described above, techniques from one of the embodiments may readily be applied to or combined with those of other embodiments. Thus, a description of a particular technique with respect to a particular embodiment should not be interpreted as limiting that technique to that embodiment.

### 2. Example Processes

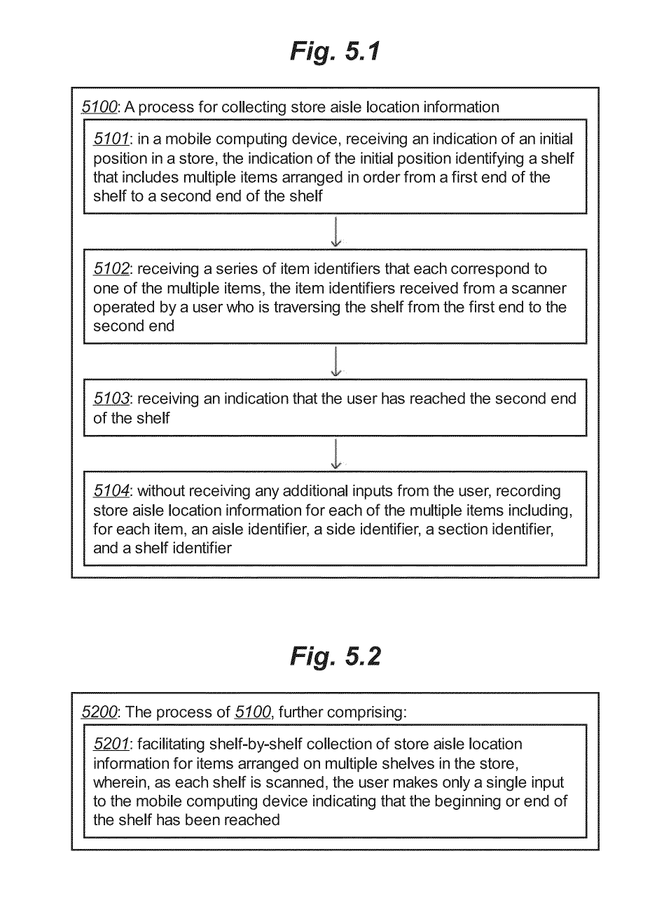

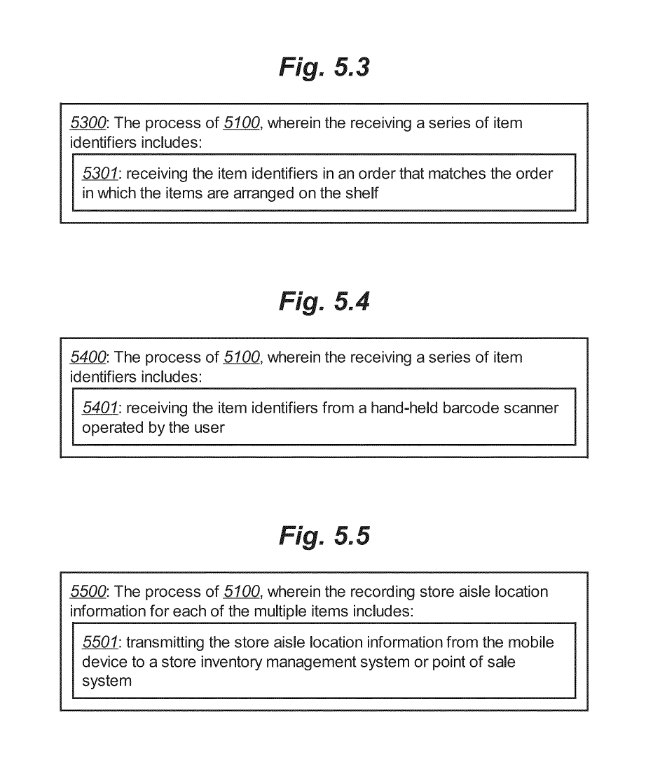

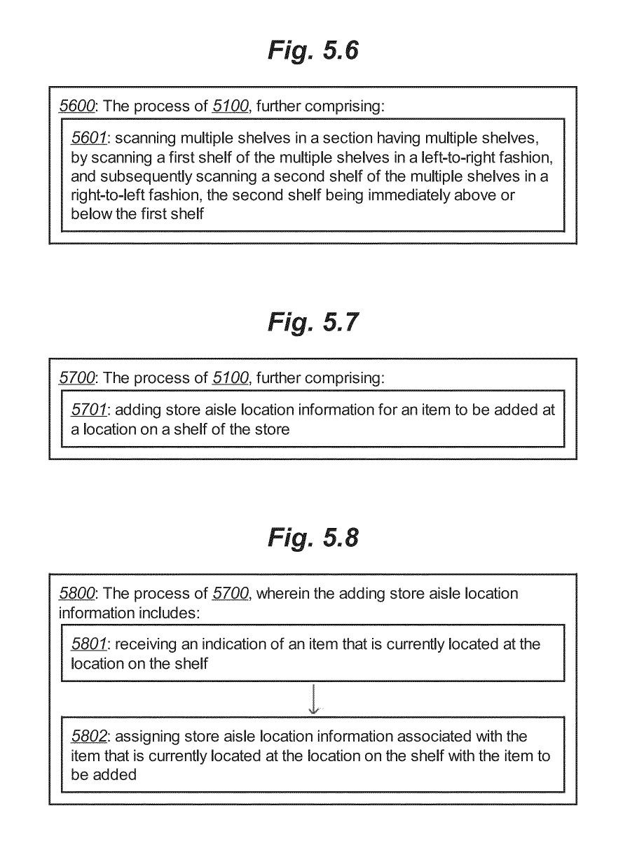

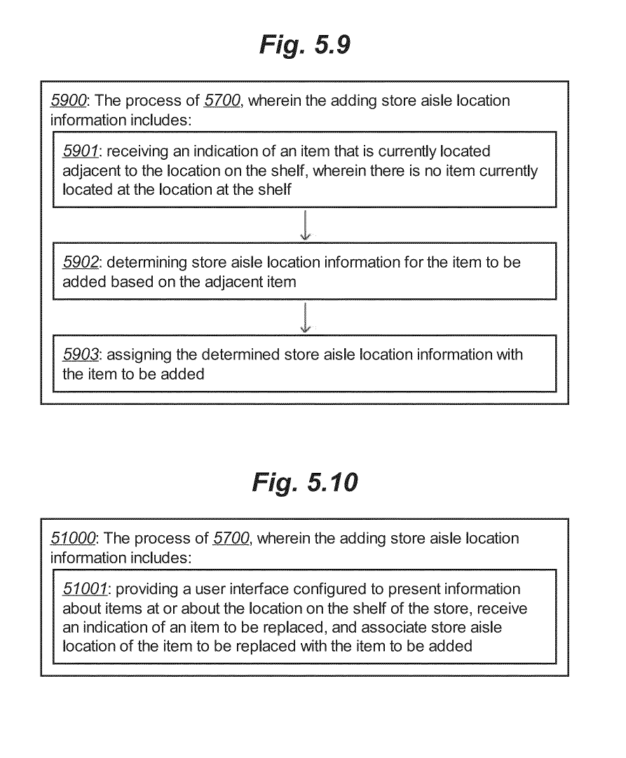

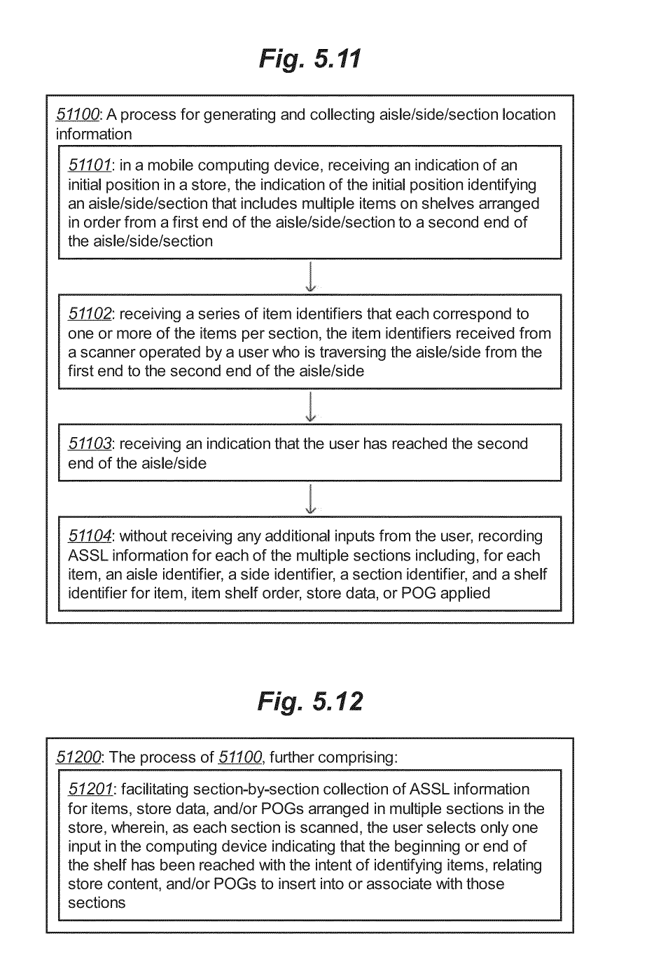

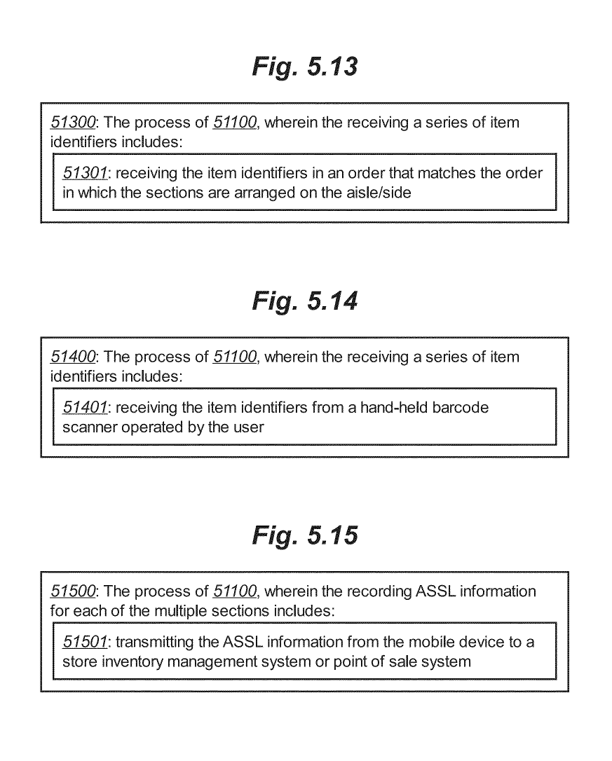

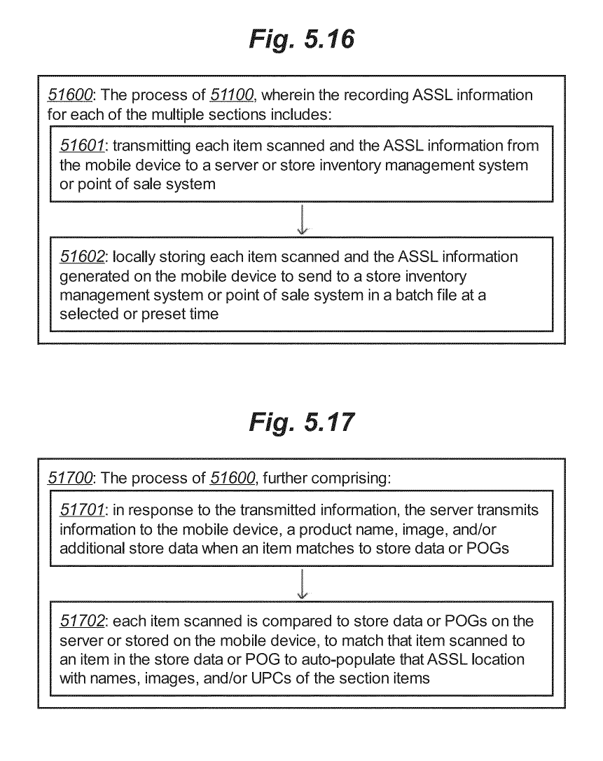

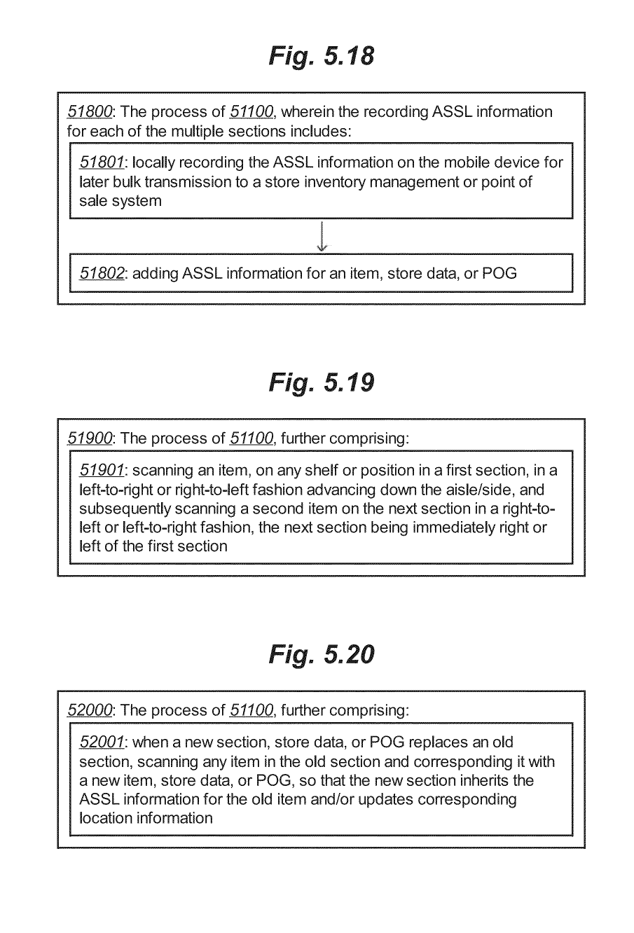

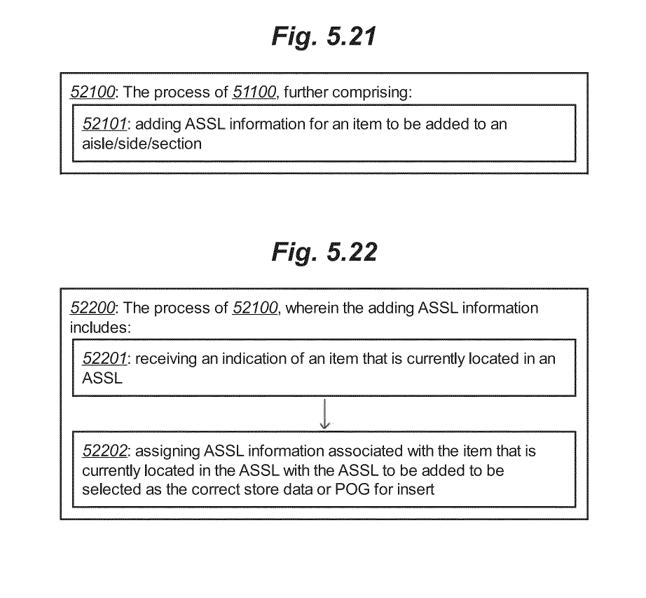

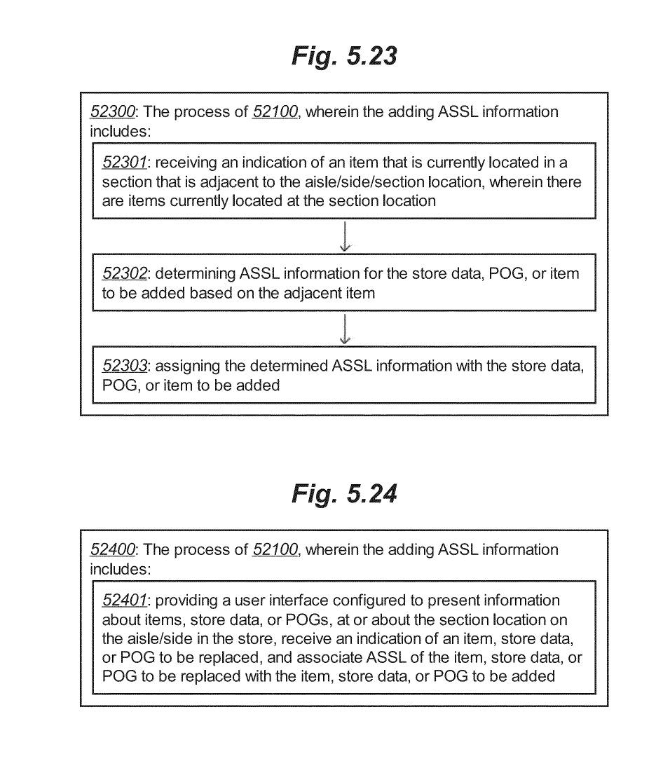

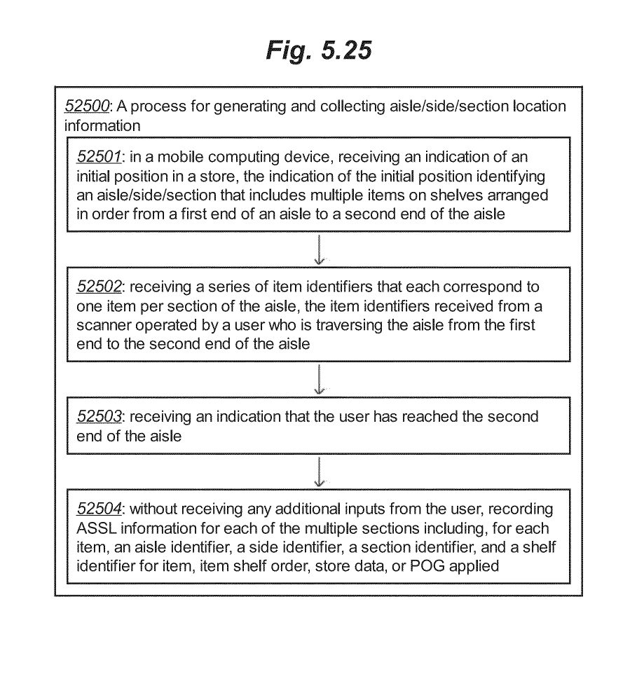

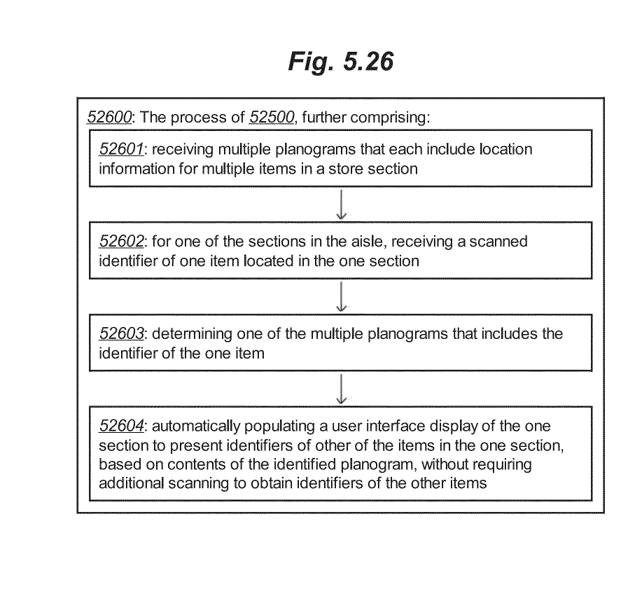

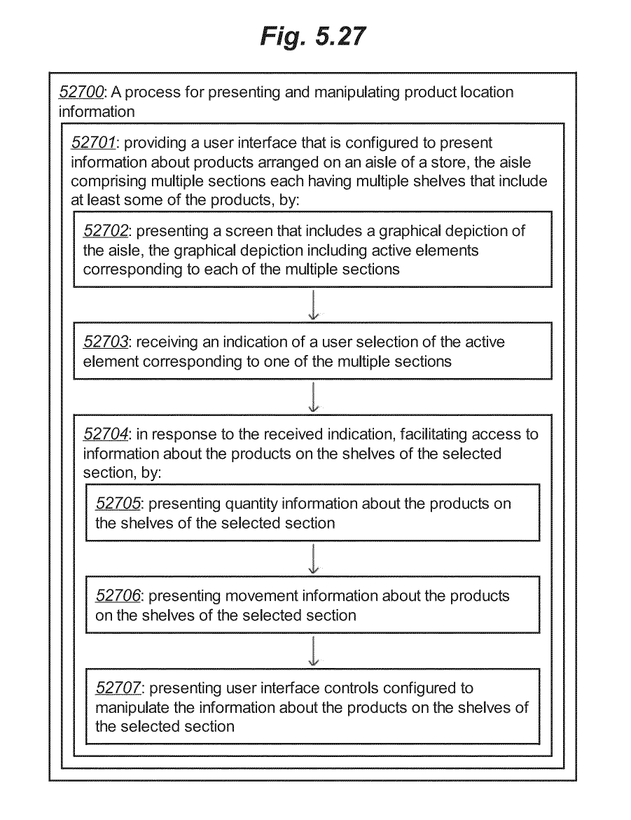

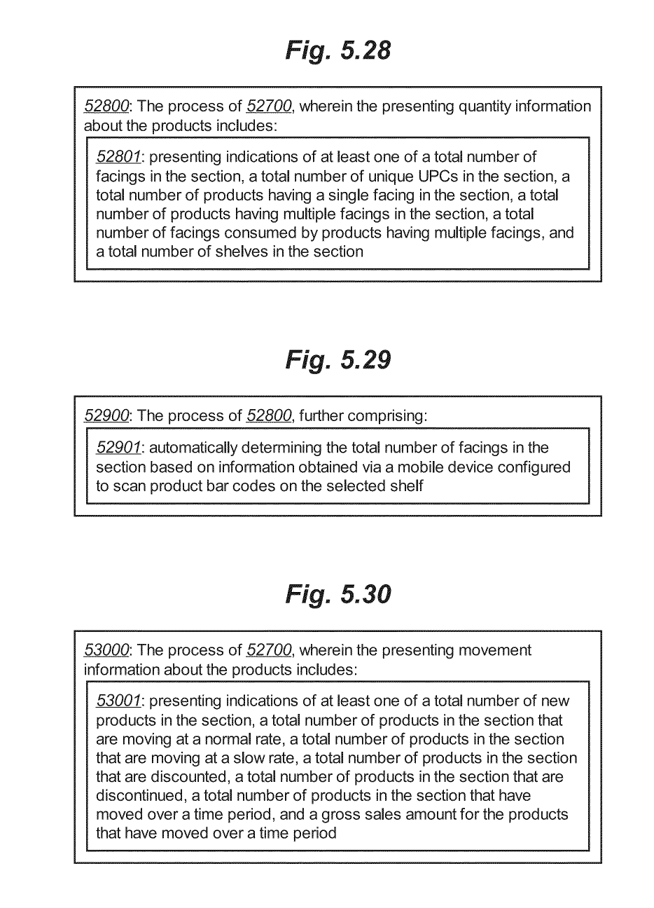

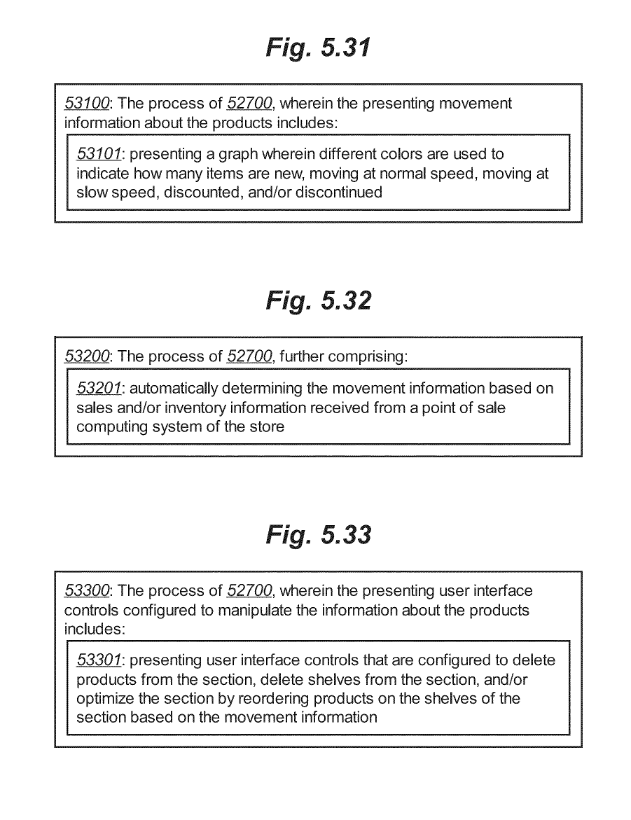

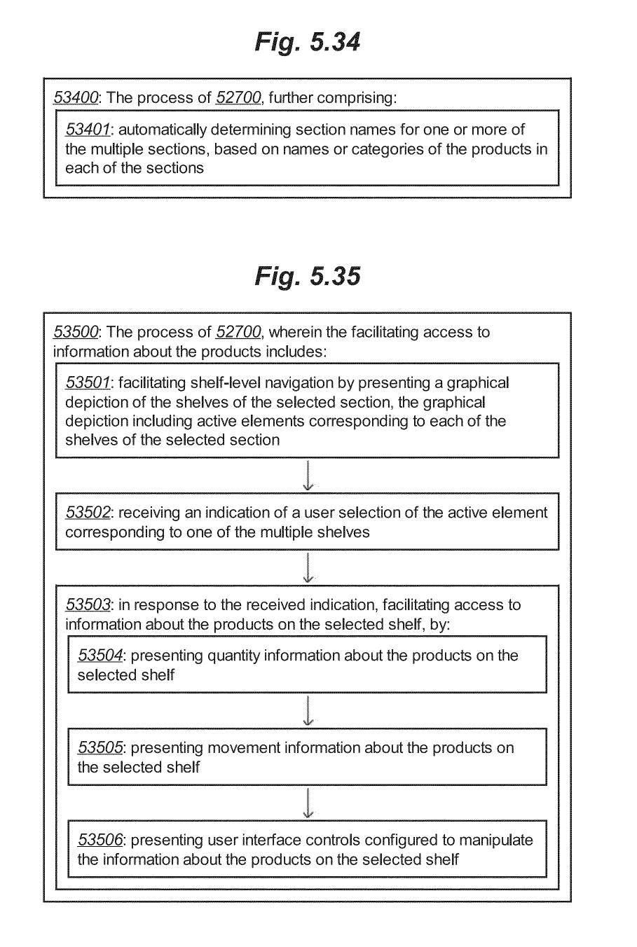

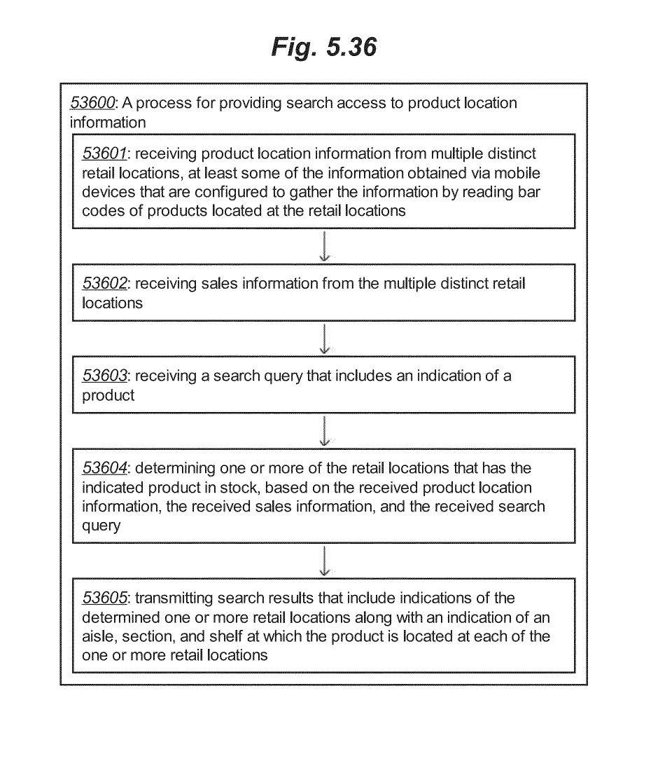

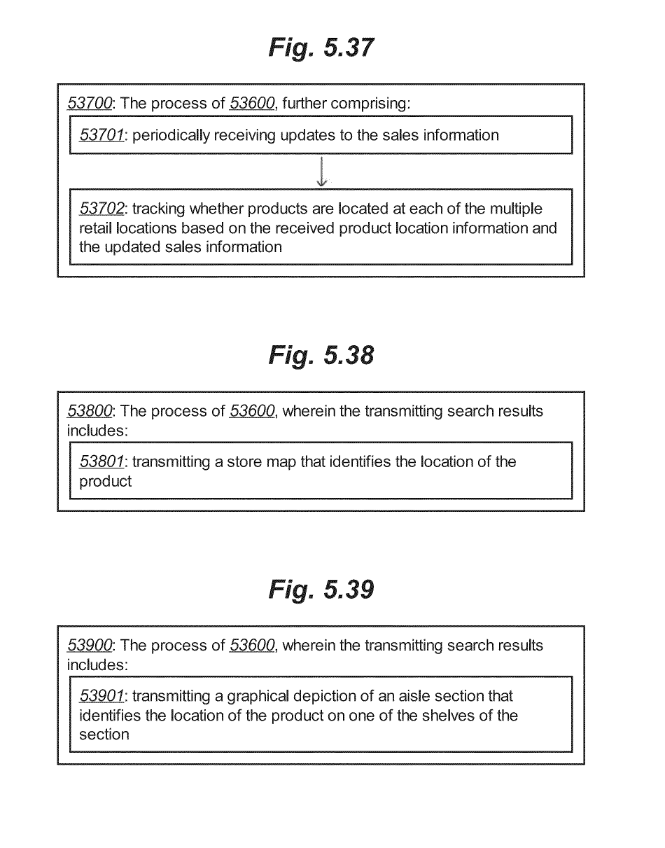

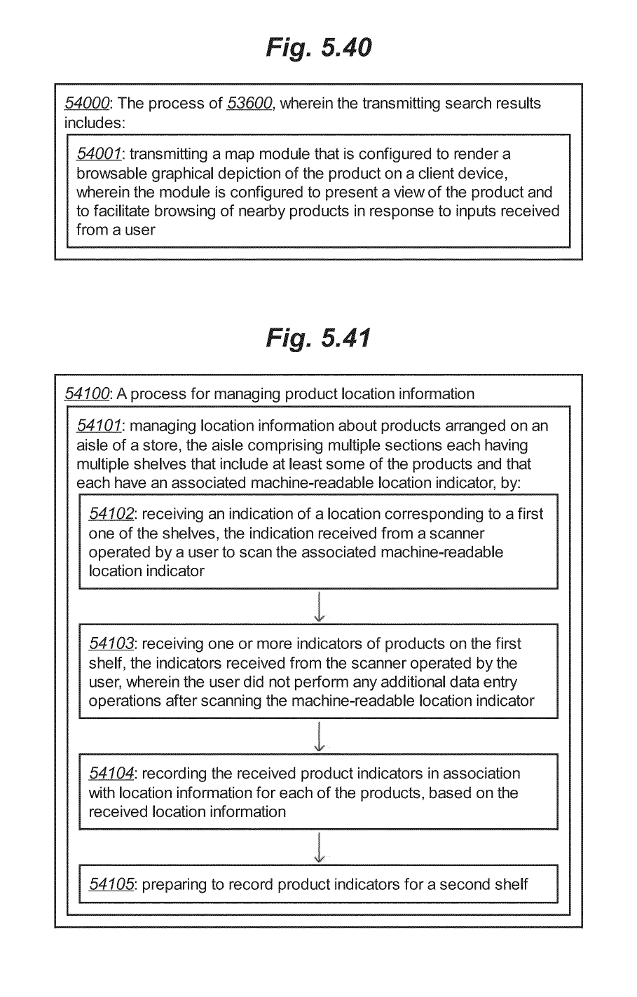

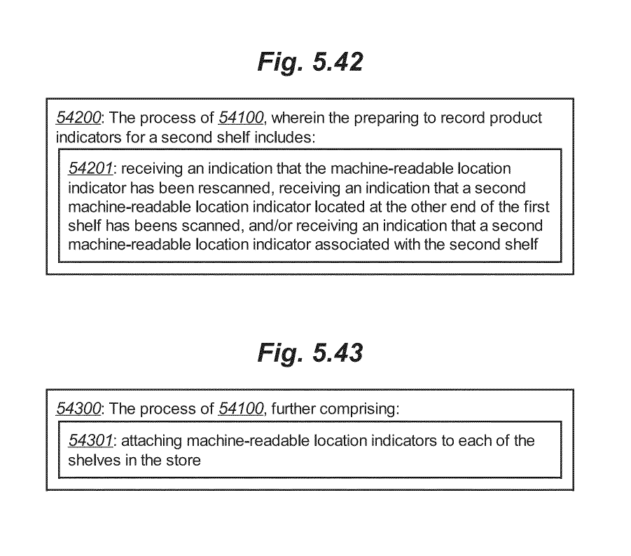

FIGS. 5.1-5.43 are example flow diagrams of product location information management processes performed by example embodiments. The following flow diagrams illustrate approaches to collecting, editing, displaying, and searching for product location information.

FIG. 5.1 is an example flow diagram of example logic for collecting store aisle location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.1 illustrates a process 5100 that includes operations performed by or at the following block(s).

At block 5101, the process performs in a mobile computing device, receiving an indication of an initial position in a store, the indication of the initial position identifying a shelf that includes multiple items arranged in order from a first end of the shelf to a second end of the shelf. The initial position may include other information, including store area, store aisle, aisle section, and the like.

At block 5102, the process performs receiving a series of item identifiers that each correspond to one of the multiple items, the item identifiers received from a scanner operated by a user who is traversing the shelf from the first end to the second end. Typically, a user will scan items on a shelf in sequence (e.g., from left to right). In some embodiments, as each item is scanned, the mobile device will receive item identifiers read by the scanner, such as UPC codes, generate related SAL information, and record the generated information on a local or remote data store.

At block 5103, the process performs receiving an indication that the user has reached the second end of the shelf. The user may press a button or make some other input to indicate that he has reached the end of a shelf.

At block 5104, the process performs without receiving any additional inputs from the user, recording store aisle location information for each of the multiple items including, for each item, an aisle identifier, a side identifier, a section identifier, and a shelf identifier. The process may automatically record such information, without the user every manually providing it for any of the items. The information may be recorded locally or remotely, and in a batch or iterative manner. In some embodiments, the process may collect an entire shelf's worth of information, and then record it remotely when the end of the shelf is reached. In some embodiments, the process may remotely record information as each item is scanned. As each item is scanned, the process may also display information about that item beyond its scanned identifier, such as the product name, so that a user can easily determine that the item has been scanned correctly.

FIG. 5.2 is an example flow diagram of example logic illustrating an example embodiment of process 5100 of FIG. 5.1. More particularly, FIG. 5.2 illustrates a process 5200 that includes the process 5100, and which further includes operations performed by or at the following block(s).

At block 5201, the process performs facilitating shelf-by-shelf collection of store aisle location information for items arranged on multiple shelves in the store, wherein, as each shelf is scanned, the user makes only a single input to the mobile computing device indicating that the beginning or end of the shelf has been reached. Typically, the user can scan an entire side of an aisle, side, section, or stack of shelves with making only a single input at the end or beginning of each shelf.

FIG. 5.3 is an example flow diagram of example logic illustrating an example embodiment of process 5100 of FIG. 5.1. More particularly, FIG. 5.3 illustrates a process 5300 that includes the process 5100, wherein the receiving a series of item identifiers includes operations performed by or at one or more of the following block(s).

At block 5301, the process performs receiving the item identifiers in an order that matches the order in which the items are arranged on the shelf. As noted, as items are scanned one after another, a sequence of identifiers is provided from the scanner to the mobile device (or system 100), where the sequence will be in the same order as the items are arranged on the shelf. In some embodiments, item identifiers are sent to a server as they are scanned (without waiting until the end of a section/shelf is reached). In response, the server may provide product information (e.g., product name, product image), so that the user can easily determine that an item has been correctly scanned.

FIG. 5.4 is an example flow diagram of example logic illustrating an example embodiment of process 5100 of FIG. 5.1. More particularly, FIG. 5.4 illustrates a process 5400 that includes the process 5100, wherein the receiving a series of item identifiers includes operations performed by or at one or more of the following block(s).

At block 5401, the process performs receiving the item identifiers from a hand-held barcode scanner operated by the user. In other embodiments, other input devices may be used, including RFID readers or image recognition systems.

FIG. 5.5 is an example flow diagram of example logic illustrating an example embodiment of process 5100 of FIG. 5.1. More particularly, FIG. 5.5 illustrates a process 5500 that includes the process 5100, wherein the recording store aisle location information for each of the multiple items includes operations performed by or at one or more of the following block(s).

At block 5501, the process performs transmitting the store aisle location information from the mobile device to a store inventory management system or point of sale system. The mobile device may transmit store aisle location information in batch mode (e.g., an entire shelf worth of data at a time) and/or incrementally (e.g., as each item is scanned without additional input from the user).

FIG. 5.6 is an example flow diagram of example logic illustrating an example embodiment of process 5100 of FIG. 5.1. More particularly, FIG. 5.6 illustrates a process 5600 that includes the process 5100, and which further includes operations performed by or at the following block(s).

At block 5601, the process performs scanning multiple shelves in a section having multiple shelves, by scanning a first shelf of the multiple shelves in a left-to-right fashion, and subsequently scanning a second shelf of the multiple shelves in a right-to-left fashion, the second shelf being immediately above or below the first shelf. Some embodiments support a “sidewinder” mode of data collection, in which the user scans shelves in a zig-zag pattern (e.g., first shelf left to right, second shelf right to left, and so on down the section of shelves). Such a data collection technique significantly reduces the amount of travel for the user, as they are able to scan a next shelf starting at the end of the previous shelf at which they finished scanning.

FIG. 5.7 is an example flow diagram of example logic illustrating an example embodiment of process 5100 of FIG. 5.1. More particularly, FIG. 5.7 illustrates a process 5700 that includes the process 5100, and which further includes operations performed by or at the following block(s).

At block 5701, the process performs adding store aisle location information for an item to be added at a location on a shelf of the store.

FIG. 5.8 is an example flow diagram of example logic illustrating an example embodiment of process 5700 of FIG. 5.7. More particularly, FIG. 5.8 illustrates a process 5800 that includes the process 5700, wherein the adding store aisle location information includes operations performed by or at one or more of the following block(s).

At block 5801, the process performs receiving an indication of an item that is currently located at the location on the shelf. When a new item replaces an old item on a shelf, the user may scan the old item and correspond it with the new item, so that the new item inherits the store aisle location information for the old item.

At block 5802, the process performs assigning store aisle location information associated with the item that is currently located at the location on the shelf with the item to be added.

FIG. 5.9 is an example flow diagram of example logic illustrating an example embodiment of process 5700 of FIG. 5.7. More particularly, FIG. 5.9 illustrates a process 5900 that includes the process 5700, wherein the adding store aisle location information includes operations performed by or at one or more of the following block(s).

At block 5901, the process performs receiving an indication of an item that is currently located adjacent to the location on the shelf, wherein there is no item currently located at the location at the shelf. When a new item replaces an old item that is no longer on the shelf (e.g., because it has sold out), the user may scan an item adjacent to the location of the old item, so that the store aisle location for the old item can be determined and applied to the new item.

At block 5902, the process performs determining store aisle location information for the item to be added based on the adjacent item.

At block 5903, the process performs assigning the determined store aisle location information with the item to be added.

FIG. 5.10 is an example flow diagram of example logic illustrating an example embodiment of process 5700 of FIG. 5.7. More particularly, FIG. 5.10 illustrates a process 51000 that includes the process 5700, wherein the adding store aisle location information includes operations performed by or at one or more of the following block(s).

At block 51001, the process performs providing a user interface configured to present information about items at or about the location on the shelf of the store, receive an indication of an item to be replaced, and associate store aisle location of the item to be replaced with the item to be added. In some embodiments, the aisle need not be visited at all to determine the store aisle location for the new item. Instead, a virtual shelf or other interface may be displayed with which a user can identify the location for the new item.

FIG. 5.11 is an example flow diagram of example logic for generating and collecting aisle/side/section location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.11 illustrates a process 51100 that includes operations performed by or at the following block(s).

At block 51101, the process performs in a mobile computing device, receiving an indication of an initial position in a store, the indication of the initial position identifying an aisle/side/section that includes multiple items on shelves arranged in order from a first end of the aisle/side/section to a second end of the aisle/side/section. The initial position may include other information, including store area, store aisle, aisle section, product category, and the like.

At block 51102, the process performs receiving a series of item identifiers that each correspond to one or more of the items per section, the item identifiers received from a scanner operated by a user who is traversing the aisle/side from the first end to the second end of the aisle/side. Typically, a user will scan an aisle in a section-by-section manner, such as by scanning a single item per section as the user travels down the store aisle. As each item is scanned, the mobile device will receive item identifiers read by the scanner, such as UPC codes, generate the related ASSL identifier and save them in real time communicating with System 100 for each item scanned.

At block 51103, the process performs receiving an indication that the user has reached the second end of the aisle/side. The user may press a button or make some other input to indicate that he has reached the end of an aisle side. Each item scanned has been compared to a store's data pool and POGs, to automatically retrieve store data and assign store content to the particular section in which the item scanned resides, as determined by System 100 or some other logic.

At block 51104, the process performs without receiving any additional inputs from the user, recording ASSL information for each of the multiple sections including, for each item, an aisle identifier, a side identifier, a section identifier, and a shelf identifier for item, item shelf order, store data, or POG applied. The process may automatically record such information, without the user ever manually providing it for any of the items. The information may be recorded locally or remotely, and in a batch or iterative manner. As or some time after each item is scanned, the process may also display information about that item beyond its scanned identifier, such as the product name, so that a user can easily determine that the item has been scanned correctly.

FIG. 5.12 is an example flow diagram of example logic illustrating an example embodiment of process 51100 of FIG. 5.11. More particularly, FIG. 5.12 illustrates a process 51200 that includes the process 51100, and which further includes operations performed by or at the following block(s).

At block 51201, the process performs facilitating section-by-section collection of ASSL information for items, store data, and/or POGs arranged in multiple sections in the store, wherein, as each section is scanned, the user selects only one input in the computing device indicating that the beginning or end of the shelf has been reached with the intent of identifying items, relating store content, and/or POGs to insert into or associate with those sections. Typically, the user can scan an entire side of an aisle with making only a single input at the end or beginning of each section besides simply scanning an item in each section on that aisle side.

FIG. 5.13 is an example flow diagram of example logic illustrating an example embodiment of process 51100 of FIG. 5.11. More particularly, FIG. 5.13 illustrates a process 51300 that includes the process 51100, wherein the receiving a series of item identifiers includes operations performed by or at one or more of the following block(s).

At block 51301, the process performs receiving the item identifiers in an order that matches the order in which the sections are arranged on the aisle/side. As noted, as each item is scanned, one in each section, a sequence of identifiers is provided from the scanner to the mobile device, where the sequence order of the items is used to arrange section positions on the aisle/side. The identifiers are (in real time) sent to a server, and a response from the server provides item product information for the user to reference when correcting a mistake while inputting data.

FIG. 5.14 is an example flow diagram of example logic illustrating an example embodiment of process 51100 of FIG. 5.11. More particularly, FIG. 5.14 illustrates a process 51400 that includes the process 51100, wherein the receiving a series of item identifiers includes operations performed by or at one or more of the following block(s).

At block 51401, the process performs receiving the item identifiers from a hand-held barcode scanner operated by the user. In other embodiments, other input devices may be used, including RFID readers, keyboards, touchpads, image recognition, or voice recognition systems.

FIG. 5.15 is an example flow diagram of example logic illustrating an example embodiment of process 51100 of FIG. 5.11. More particularly, FIG. 5.15 illustrates a process 51500 that includes the process 51100, wherein the recording ASSL information for each of the multiple sections includes operations performed by or at one or more of the following block(s).

At block 51501, the process performs transmitting the ASSL information from the mobile device to a store inventory management system or point of sale system. The mobile device may transmit ASSL information in batch mode (e.g., an entire shelf worth of data at a time) and/or incrementally (e.g., as each item is scanned and without the user having to initiate a batch operation).

FIG. 5.16 is an example flow diagram of example logic illustrating an example embodiment of process 51100 of FIG. 5.11. More particularly, FIG. 5.16 illustrates a process 51600 that includes the process 51100, wherein the recording ASSL information for each of the multiple sections includes operations performed by or at one or more of the following block(s).

At block 51601, the process performs transmitting each item scanned and the ASSL information from the mobile device to a server or store inventory management system or point of sale system.

At block 51602, the process performs locally storing each item scanned and the ASSL information generated on the mobile device to send to a store inventory management system or point of sale system in a batch file at a selected or preset time.

FIG. 5.17 is an example flow diagram of example logic illustrating an example embodiment of process 51600 of FIG. 5.16. More particularly, FIG. 5.17 illustrates a process 51700 that includes the process 51600, and which further includes operations performed by or at the following block(s).

At block 51701, the process performs in response to the transmitted information, the server transmits information to the mobile device, a product name, image, and/or additional store data when an item matches to store data or POGs. In response to the request, the mobile device receives from the server a product name, brand, aisle/side/section location information if a record exists, and the assignment of any store data or POGs found through the process. Every item scanned in a section is used to search all store data, and or POGs, to then assign that store data or POG to that exact aisle/side/section location determined by the process of finding the item 150b scanned and the store data or POG that contains that 150b automatically adjusting all sections and shelves for all or any aisle/side sections affected by the POG insert.

At block 51702, the process performs each item scanned is compared to store data or POGs on the server or stored on the mobile device, to match that item scanned to an item in the store data or POG to auto-populate that ASSL location with names, images, and/or UPCs of the section items.

FIG. 5.18 is an example flow diagram of example logic illustrating an example embodiment of process 51100 of FIG. 5.11. More particularly, FIG. 5.18 illustrates a process 51800 that includes the process 51100, wherein the recording ASSL information for each of the multiple sections includes operations performed by or at one or more of the following block(s).

At block 51801, the process performs locally recording the ASSL information on the mobile device for later bulk transmission to a store inventory management or point of sale system.

At block 51802, the process performs adding ASSL information for an item, store data, or POG. The process will automatically adjust all items, in all sections, that require new ASSLs on the mobile device for update in a batch file at a selected time or a preset time.

FIG. 5.19 is an example flow diagram of example logic illustrating an example embodiment of process 51100 of FIG. 5.11. More particularly, FIG. 5.19 illustrates a process 51900 that includes the process 51100, and which further includes operations performed by or at the following block(s).

At block 51901, the process performs scanning an item, on any shelf or position in a first section, in a left-to-right or right-to-left fashion advancing down the aisle/side, and subsequently scanning a second item on the next section in a right-to-left or left-to-right fashion, the next section being immediately right or left of the first section. As noted, a user can walk the aisle, scanning a single item per section.

FIG. 5.20 is an example flow diagram of example logic illustrating an example embodiment of process 51100 of FIG. 5.11. More particularly, FIG. 5.20 illustrates a process 52000 that includes the process 51100, and which further includes operations performed by or at the following block(s).

At block 52001, the process performs when a new section, store data, or POG replaces an old section, scanning any item in the old section and corresponding it with a new item, store data, or POG, so that the new section inherits the ASSL information for the old item and/or updates corresponding location information. By scanning any single item, on any shelf, in the next adjunct section, each item scanned is compared to store data or POGs in real time, to match that items canned, to an item in the store data or POG to auto-populate that ASSL information with the format of shelves and item order in that store data.

FIG. 5.21 is an example flow diagram of example logic illustrating an example embodiment of process 51100 of FIG. 5.11. More particularly, FIG. 5.21 illustrates a process 52100 that includes the process 51100, and which further includes operations performed by or at the following block(s).

At block 52101, the process performs adding ASSL information for an item to be added to an aisle/side/section.

FIG. 5.22 is an example flow diagram of example logic illustrating an example embodiment of process 52100 of FIG. 5.21. More particularly, FIG. 5.22 illustrates a process 52200 that includes the process 52100, wherein the adding ASSL information includes operations performed by or at one or more of the following block(s).

At block 52201, the process performs receiving an indication of an item that is currently located in an ASSL. When new ASSL, store data, or POG replaces previously assigned ASSL, the user may scan the old item in the old ASSL and correspond it with the item in the new store data or POG, so that the new item store data or POG inherits the ASSL information for the old item.

At block 52202, the process performs assigning ASSL information associated with the item that is currently located in the ASSL with the ASSL to be added to be selected as the correct store data or POG for insert.

FIG. 5.23 is an example flow diagram of example logic illustrating an example embodiment of process 52100 of FIG. 5.21. More particularly, FIG. 5.23 illustrates a process 52300 that includes the process 52100, wherein the adding ASSL information includes operations performed by or at one or more of the following block(s).

At block 52301, the process performs receiving an indication of an item that is currently located in a section that is adjacent to the aisle/side/section location, wherein there are items currently located at the section location. When a new item store data or POGs replaces old store data or POGs that is no longer on any shelf in a section (e.g., because it has sold out, because of a store reset of products), the user may scan an item adjacent to the section location of the old item, so that the ASSL for the old item can be determined and applied to the new store data, POG, or item.

At block 52302, the process performs determining ASSL information for the store data, POG, or item to be added based on the adjacent item.

At block 52303, the process performs assigning the determined ASSL information with the store data, POG, or item to be added.

FIG. 5.24 is an example flow diagram of example logic illustrating an example embodiment of process 52100 of FIG. 5.21. More particularly, FIG. 5.24 illustrates a process 52400 that includes the process 52100, wherein the adding ASSL information includes operations performed by or at one or more of the following block(s).

At block 52401, the process performs providing a user interface configured to present information about items, store data, or POGs, at or about the section location on the aisle/side in the store, receive an indication of an item, store data, or POG to be replaced, and associate ASSL of the item, store data, or POG to be replaced with the item, store data, or POG to be added. In some embodiments, the aisle need not be visited at all to determine the product aisle location for the new item. Instead, a virtual shelf or other interface may be displayed with which a user can identify the location for the new item, store data, or POG.

FIG. 5.25 is an example flow diagram of example logic for generating and collecting aisle/side/section location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.25 illustrates a process 52500 that includes operations performed by or at the following block(s).

At block 52501, the process performs in a mobile computing device, receiving an indication of an initial position in a store, the indication of the initial position identifying an aisle/side/section that includes multiple items on shelves arranged in order from a first end of an aisle to a second end of the aisle. The initial position may include other information, including store area, store aisle, aisle section, product category, and the like.

At block 52502, the process performs receiving a series of item identifiers that each correspond to one item per section of the aisle, the item identifiers received from a scanner operated by a user who is traversing the aisle from the first end to the second end of the aisle. Typically, a user will scan an aisle in a section-by-section manner, such as by scanning a single item per section as the user travels down the store aisle. As each item is scanned, the mobile device will receive item identifiers read by the scanner, such as UPC codes, generate the related ASSL identifier and save them in real time communicating with System 100 for each item scanned.

At block 52503, the process performs receiving an indication that the user has reached the second end of the aisle. The user may press a button or make some other input to indicate that he has reached the end of an aisle side. Each item scanned has been compared to a store's data pool and POGs, to automatically retrieve store data and assign store content to the particular section in which the item scanned resides, as determined by System 100 or some other logic.

At block 52504, the process performs without receiving any additional inputs from the user, recording ASSL information for each of the multiple sections including, for each item, an aisle identifier, a side identifier, a section identifier, and a shelf identifier for item, item shelf order, store data, or POG applied. For each item, the process determines or identifies additional information from various sources. For example, given an item, the process may determine other items in the item's section by referencing a POG that represents the layout of that section. With this information, the process can “fill in” or auto-populate any and all of the other items in the section, without the user having to manually scan them. In this manner, the process can build up a master record or database that accurately reflects the section layout of every section in every aisle of a store. The information in this database can be modified by further scanning operations (e.g., to correct errors or to add/delete items). In addition, this information can be exported to other formats, such as by outputting a POG or inserting data into an inventory management or point of sale system.

FIG. 5.26 is an example flow diagram of example logic illustrating an example embodiment of process 52500 of FIG. 5.25. More particularly, FIG. 5.26 illustrates a process 52600 that includes the process 52500, and which further includes operations performed by or at the following block(s).

At block 52601, the process performs receiving multiple planograms that each include location information for multiple items in a store section. Each planogram may be a file or other record that includes an idealized mapping, ordering, and/or positioning of items in a section. Multiple planogram files may be available, but these are typically not connected to the actual layout of items in a store. Also, a planogram may include errors or otherwise not match the actual physical layout of a store section.

At block 52602, the process performs for one of the sections in the aisle, receiving a scanned identifier of one item located in the one section. As discussed above, a user operating a scanner scans one item per section of an aisle.

At block 52603, the process performs determining one of the multiple planograms that includes the identifier of the one item. The planograms are searched to find a matching planogram. If multiple planograms match, the user may be prompted to select one or enter other information, such as by scanning another item in the section.

At block 52604, the process performs automatically populating a user interface display of the one section to present identifiers of other of the items in the one section, based on contents of the identified planogram, without requiring additional scanning to obtain identifiers of the other items. Once a matching planogram has been identified, the information therein can be used to populate a user interface display that presents the items located in the section. The user can then review this presentation for correctness. The user may correct the information, such as by indicating additional items located on the shelf (e.g., by scanning the additional items), or by indicating items that are not located on the shelf (e.g., by interacting with the user interface to delete an item).

FIG. 5.27 is an example flow diagram of example logic for presenting and manipulating product location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.27 illustrates a process 52700 that includes operations performed by or at the following block(s).

At block 52701, the process performs providing a user interface that is configured to present information about products arranged on an aisle of a store, the aisle comprising multiple sections each having multiple shelves that include at least some of the products, by: performing operation(s) of block(s) 52702, 52703 and 52704, described below. The user interface may be provided to a remote client device, so that a user of the device can access and manipulate product location information. In some embodiments, the user interface may be provided via a Web-based system, such as by a Web server to a browser client. In some embodiments, the user interface may be a part of a standalone application, such as a desktop application.

At block 52702, the process performs presenting a screen that includes a graphical depiction of the aisle, the graphical depiction including active elements corresponding to each of the multiple sections. The graphical depiction may be a map, diagram, chart, or other representation of the aisle. In some embodiments, the depiction may be part of a store-level map browser or layout. Typically, the map is automatically generated based on product location information obtained from scanning client devices as described herein. The graphical depiction also includes active elements that may be buttons or other responsive user interface elements that, when selected by the user, facilitate browsing, access, and/or manipulation of the underlying data. Example graphical and textual maps are shown and described with respect to FIGS. 3.2A and 3.2B. Examples of section-level browsing are shown and described with respect to FIG. 3.2C.

At block 52703, the process performs receiving an indication of a user selection of the active element corresponding to one of the multiple sections. Receiving the indication may include receiving an indication that the user has clicked on or otherwise selected an active portion of the map or other representation that corresponds to one of the store aisles.

At block 52704, the process performs in response to the received indication, facilitating access to information about the products on the shelves of the selected section, by: performing operation(s) of block(s) 52705, 52706 and 52707, described below. Facilitating access may include presenting another user interface (or modifying an existing interface) to display an aisle-level or section-level browser or other navigation component.

At block 52705, the process performs presenting quantity information about the products on the shelves of the selected section. Quantity information may include textual or graphical indications of the number of items in the section, including total number of items, total facings, or the like. Such information may be presented numerically or by way of a chart or other mechanism.

At block 52706, the process performs presenting movement information about the products on the shelves of the selected section. Movement information may include textual or graphical indications of sales-related information, such as how many units of a given product have been sold during a particular time period.

At block 52707, the process performs presenting user interface controls configured to manipulate the information about the products on the shelves of the selected section. The presented user interface controls may facilitate the addition or removal of products to the section shelves, such as may occur when old or ineffective products are removed and/or replaced by other products.

FIG. 5.28 is an example flow diagram of example logic illustrating an example embodiment of process 52700 of FIG. 5.27. More particularly, FIG. 5.28 illustrates a process 52800 that includes the process 52700, wherein the presenting quantity information about the products includes operations performed by or at one or more of the following block(s).

At block 52801, the process performs presenting indications of at least one of a total number of facings in the section, a total number of unique UPCs in the section, a total number of products having a single facing in the section, a total number of products having multiple facings in the section, a total number of facings consumed by products having multiple facings, and a total number of shelves in the section. Note that the presentation may be textual (e.g., numerals and characters) or graphical (e.g., via a bar graph).

FIG. 5.29 is an example flow diagram of example logic illustrating an example embodiment of process 52800 of FIG. 5.28. More particularly, FIG. 5.29 illustrates a process 52900 that includes the process 52800, and which further includes operations performed by or at the following block(s).

At block 52901, the process performs automatically determining the total number of facings in the section based on information obtained via a mobile device configured to scan product bar codes on the selected shelf. In some embodiments, the process automatically determines at least some of the quantity information. For example, the process may determine the total number of facings in the section based on information determined or obtained during a scanning process performed at the store location, where a human operates a scanning device to scan UPCs or other identifiers of shelved products. Other information about facings may be similarly determined, such as the number of multiple facings (e.g., a single product occupying more than one shelf position), the number of single facings, or the like.

FIG. 5.30 is an example flow diagram of example logic illustrating an example embodiment of process 52700 of FIG. 5.27. More particularly, FIG. 5.30 illustrates a process 53000 that includes the process 52700, wherein the presenting movement information about the products includes operations performed by or at one or more of the following block(s).

At block 53001, the process performs presenting indications of at least one of a total number of new products in the section, a total number of products in the section that are moving at a normal rate, a total number of products in the section that are moving at a slow rate, a total number of products in the section that are discounted, a total number of products in the section that are discontinued, a total number of products in the section that have moved over a time period, and a gross sales amount for the products that have moved over a time period. In some embodiments, the process provides sales-related information to the viewer, such as the owner or manager of the store, who may determine whether products are selling (moving) effectively in their current location, how much total revenue is being obtained by a particular shelf or section, whether to rotate stock or replace poor performing items, or the like.

FIG. 5.31 is an example flow diagram of example logic illustrating an example embodiment of process 52700 of FIG. 5.27. More particularly, FIG. 5.31 illustrates a process 53100 that includes the process 52700, wherein the presenting movement information about the products includes operations performed by or at one or more of the following block(s).

At block 53101, the process performs presenting a graph wherein different colors are used to indicate how many items are new, moving at normal speed, moving at slow speed, discounted, and/or discontinued. Examples graphs used in various embodiments include pie, line or bar graphs.

FIG. 5.32 is an example flow diagram of example logic illustrating an example embodiment of process 52700 of FIG. 5.27. More particularly, FIG. 5.32 illustrates a process 53200 that includes the process 52700, and which further includes operations performed by or at the following block(s).

At block 53201, the process performs automatically determining the movement information based on sales and/or inventory information received from a point of sale computing system of the store. The process may receive the sales/inventory information in a push, pull, time-based or other manner. The sales/inventory information may then be processed to determine how many units of store products have been sold during a specified time interval, such as the last week or month.

FIG. 5.33 is an example flow diagram of example logic illustrating an example embodiment of process 52700 of FIG. 5.27. More particularly, FIG. 5.33 illustrates a process 53300 that includes the process 52700, wherein the presenting user interface controls configured to manipulate the information about the products includes operations performed by or at one or more of the following block(s).

At block 53301, the process performs presenting user interface controls that are configured to delete products from the section, delete shelves from the section, and/or optimize the section by reordering products on the shelves of the section based on the movement information. The presented user interface controls may be used by a manager or other user in order to reorganize the contents of a store shelf or section. In some embodiments, a facility for automatically optimizing a shelf or section layout may be provided. A section may be optimized, for example, by moving or removing poorly performing items, adding facings for successful items, or the like. In some embodiments, optimization may be based on sales information received from other stores indicating that other product location configurations result in higher sales. For example, the process may utilize the fact that a particular brand of cereal has sold well at a higher shelf location in other stores in order to make a a recommendation to move the product to the higher shelf at the current store. Also, some embodiments may perform “experiments,” such as by assigning a product to random locations at different stores, and then analyzing resulting sales data for the product to identify the best-selling location.

FIG. 5.34 is an example flow diagram of example logic illustrating an example embodiment of process 52700 of FIG. 5.27. More particularly, FIG. 5.34 illustrates a process 53400 that includes the process 52700, and which further includes operations performed by or at the following block(s).

At block 53401, the process performs automatically determining section names for one or more of the multiple sections, based on names or categories of the products in each of the sections. In some embodiments, the process may automatically determine a section name based on the most frequently occurring product or product category (e.g., spices, soup, cookies, chips, soft drinks) in the section. Furthermore, some embodiments may perform machine learning or classification techniques. For example, a Bayesian classifier, neural network, or similar machine learning component may be used to classify a section based on the products located there.

FIG. 5.35 is an example flow diagram of example logic illustrating an example embodiment of process 52700 of FIG. 5.27. More particularly, FIG. 5.35 illustrates a process 53500 that includes the process 52700, wherein the facilitating access to information about the products includes operations performed by or at one or more of the following block(s).

At block 53501, the process performs facilitating shelf-level navigation by presenting a graphical depiction of the shelves of the selected section, the graphical depiction including active elements corresponding to each of the shelves of the selected section. In some embodiments, when a user selects an active element corresponding to a shelf, a shelf-level browser or other user interface control is presented. The shelf-level browser allows a user to select, obtain, and/or manipulate information about individual products located on the selected shelf. Shelf-level browsing shown and described with respect to FIGS. 3.2C and 3.2D.

At block 53502, the process performs receiving an indication of a user selection of the active element corresponding to one of the multiple shelves.

At block 53503, the process performs in response to the received indication, facilitating access to information about the products on the selected shelf, by: performing operation(s) of block(s) 53504, 53505 and 53506, described below.

At block 53504, the process performs presenting quantity information about the products on the selected shelf.

At block 53505, the process performs presenting movement information about the products on the selected shelf.

At block 53506, the process performs presenting user interface controls configured to manipulate the information about the products on the selected shelf.

FIG. 5.36 is an example flow diagram of example logic for providing search access to product location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.36 illustrates a process 53600 that includes operations performed by or at the following block(s).

At block 53601, the process performs receiving product location information from multiple distinct retail locations, at least some of the information obtained via mobile devices that are configured to gather the information by reading bar codes of products located at the retail locations. As discussed herein, the process may receive product location information via a scanning process in which a human operator uses a client scanning device to scan product identifiers (e.g., bar codes) of products in a store.

At block 53602, the process performs receiving sales information from the multiple distinct retail locations. The process further receives sales information. Such information is typically available from a store point of sale or inventory system that is configured to track and provide information about the number and identity of items sold by the store.

At block 53603, the process performs receiving a search query that includes an indication of a product. In this embodiment, the process receives a search query that includes a keyword, product category, product identifier (e.g., UPC), or the like.

At block 53604, the process performs determining one or more of the retail locations that has the indicated product in stock, based on the received product location information, the received sales information, and the received search query. Using the product location information and the sales information, the process can track the existence and corresponding location of products that are available at the multiple retail locations. Then, given the search query, the process can perform a database lookup or similar operation to determine one or more retail locations that include the indicated product.

At block 53605, the process performs transmitting search results that include indications of the determined one or more retail locations along with an indication of an aisle, section, and shelf at which the product is located at each of the one or more retail locations. The search results typically include indications of the retail locations at which the product is available, as well as information about where the product may be found at each retail location, such as by identifying the aisle, section, and shelf of the product.

FIG. 5.37 is an example flow diagram of example logic illustrating an example embodiment of process 53600 of FIG. 5.36. More particularly, FIG. 5.37 illustrates a process 53700 that includes the process 53600, and which further includes operations performed by or at the following block(s).

At block 53701, the process performs periodically receiving updates to the sales information. In some embodiments, the process may receive daily updates to sales information. Other intervals are contemplated, including at other time frames (e.g., hourly) or due to other conditions (e.g., after a certain number of items have been sold or stocked.

At block 53702, the process performs tracking whether products are located at each of the multiple retail locations based on the received product location information and the updated sales information. The process may synthesize the sales information and the location information to generate a detailed data structure that associates products with stock numbers/quantities as well as locations in corresponding retail locations.

FIG. 5.38 is an example flow diagram of example logic illustrating an example embodiment of process 53600 of FIG. 5.36. More particularly, FIG. 5.38 illustrates a process 53800 that includes the process 53600, wherein the transmitting search results includes operations performed by or at one or more of the following block(s).

At block 53801, the process performs transmitting a store map that identifies the location of the product. Some embodiments may transmit a store map or portion thereof, such as those shown and described with respect to FIGS. 3.2A, 3.2B, and the like.

FIG. 5.39 is an example flow diagram of example logic illustrating an example embodiment of process 53600 of FIG. 5.36. More particularly, FIG. 5.39 illustrates a process 53900 that includes the process 53600, wherein the transmitting search results includes operations performed by or at one or more of the following block(s).

At block 53901, the process performs transmitting a graphical depiction of an aisle section that identifies the location of the product on one of the shelves of the section. Some embodiments may transmit a shelf-level browser or similar user interface component as shown and described with respect to FIG. 3.2H.

FIG. 5.40 is an example flow diagram of example logic illustrating an example embodiment of process 53600 of FIG. 5.36. More particularly, FIG. 5.40 illustrates a process 54000 that includes the process 53600, wherein the transmitting search results includes operations performed by or at one or more of the following block(s).

At block 54001, the process performs transmitting a map module that is configured to render a browsable graphical depiction of the product on a client device, wherein the module is configured to present a view of the product and to facilitate browsing of nearby products in response to inputs received from a user. The search results may include dynamic elements, such as a browsable component that can be manipulated by the client to see what other products are available in the vicinity of the indicated product (or even elsewhere in the store).

FIG. 5.41 is an example flow diagram of example logic for managing product location information. The illustrated logic in this and the following flow diagrams may be performed by, for example, one or more modules or components of the management system 100, the mobile device 120, and/or the scanner 130 described with respect to FIG. 1.1, 2.1, 3.1, or 4.1 above. More particularly, FIG. 5.41 illustrates a process 54100 that includes operations performed by or at the following block(s).

At block 54101, the process performs managing location information about products arranged on an aisle of a store, the aisle comprising multiple sections each having multiple shelves that include at least some of the products and that each have an associated machine-readable location indicator, by: performing operation(s) of block(s) 54102, 54103, 54104 and 54105, described below.

At block 54102, the process performs receiving an indication of a location corresponding to a first one of the shelves, the indication received from a scanner operated by a user to scan the associated machine-readable location indicator. Typically, the user operates a hand-held scanner and scans a bar code that identifies the shelf and/or includes location information about the shelf. In response, the process prepares any data structures (e.g., deletes old records, creates new records) for storing product location information.

At block 54103, the process performs receiving one or more indicators of products on the first shelf, the indicators received from the scanner operated by the user, wherein the user did not perform any additional data entry operations after scanning the machine-readable location indicator. Once the user has scanned the location indicator, the user may immediately and without performing additional user inputs begin to scan items on the shelf. As products are scanned, the scanner transmits product identifiers to the process.

At block 54104, the process performs recording the received product indicators in association with location information for each of the products, based on the received location information. The process records (either as they arrive or in batch mode) the received product indicators together with location information that is based on the initial location indicator together with order and sequence information related to the products scanned. For example, the process may automatically determine shelf position by maintaining a counter that is incremented as each product indicator is received.

At block 54105, the process performs preparing to record product indicators for a second shelf. When the user finishes scanning all of the products on the first shelf, the user may signal completion in various ways, such as by re-scanning the machine-readable location indicator, scanning a second location indicator positioned at the end of the shelf, or scanning a second location indicator positioned at the beginning of the second shelf.

FIG. 5.42 is an example flow diagram of example logic illustrating an example embodiment of process 54100 of FIG. 5.41. More particularly, FIG. 5.42 illustrates a process 54200 that includes the process 54100, wherein the preparing to record product indicators for a second shelf includes operations performed by or at one or more of the following block(s).

At block 54201, the process performs receiving an indication that the machine-readable location indicator has been rescanned, receiving an indication that a second machine-readable location indicator located at the other end of the first shelf has been scanned, and/or receiving an indication that a second machine-readable location indicator associated with the second shelf.

FIG. 5.43 is an example flow diagram of example logic illustrating an example embodiment of process 54100 of FIG. 5.41. More particularly, FIG. 5.43 illustrates a process 54300 that includes the process 54100, and which further includes operations performed by or at the following block(s).

At block 54301, the process performs attaching machine-readable location indicators to each of the shelves in the store. In some embodiments, each shelf has one location indicator at each end. In other embodiments, each shelf has just one location indicator. In still other embodiments, each section includes a single location indicator and the individual shelves do not have their own location indicators.

### 3. Example Computing System Implementation

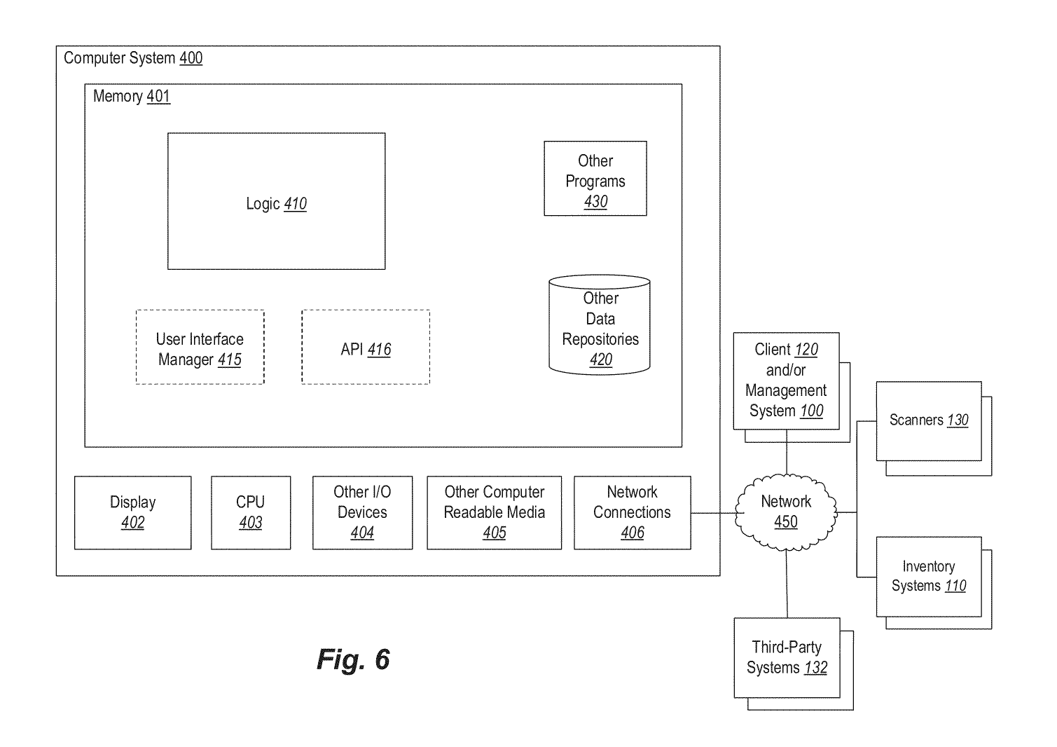

FIG. 6 is an example block diagram of an example computing system for implementing example embodiments. In particular, FIG. 6 shows a computing system 400 that may be utilized to implement the logic 122 and/or the management system 100 described with respect to FIG. 1.1, 2.1, 3.1, or 4.1. In FIG. 6, logic 410 implements the management system 100, the logic 122, or some other component or technique described herein.

Note that one or more general purpose or special purpose computing systems/devices may be used to implement the logic 410. In addition, the computing system 400 may comprise one or more distinct computing systems/devices and may span distributed locations. Furthermore, each block shown may represent one or more such blocks as appropriate to a specific embodiment or may be combined with other blocks. Also, the logic 410 may be implemented in software, hardware, firmware, or in some combination to achieve the capabilities described herein.

In the embodiment shown, the computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The system 100 is shown residing in the memory 401. In other embodiments, some portion of the contents, some or all of the components of the logic 410 may be stored on and/or transmitted over the other computer-readable media 405. The components of the logic 410 preferably execute on one or more CPUs 403 and recommend content items, as described herein. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 6 may not be present in any specific implementation. For example, some embodiments may not provide other computer readable media 405 or a display 402.

The logic 410 interacts via the network 450 with mobile (client) devices 120, management systems 100, scanners, 310, store information/inventory systems 110, and third-party systems/applications 132. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/applications 132 may include any systems that provide data to, or utilize data from, the system 100, the scanner 130, and/or the mobile device 120, including search services, Web browsers, e-commerce sites, supply chain systems, and the like.

The logic 410 is shown executing in the memory 401 of the computing system 400. Also included in the memory are a user interface manager 415 and an application program interface (“API”) 416. The user interface manager 415 and the API 416 are drawn in dashed lines to indicate that in other embodiments, functions performed by one or more of these components may be performed externally to the logic 410 or the computing system 400.

The UI manager 415 provides a view and a controller that facilitate user interaction with the logic 410 and its various components. For example, when the logic 410 implements the logic 122, the UI manager 415 may provide interactive access via client user interfaces such as those described with respect to FIG. 1.2, 2.2, or 4.3. As another example, when the logic 410 implements the system 100, the UI manager 415 may provide interactive access to the system 100, such that users can interact with the system 100 as described with respect to one or more of FIGS. 3.2A-3.2H, above. In some embodiments, access to the functionality of the UI manager 415 may be provided via a Web server, possibly executing as one of the other programs 430. In such embodiments, a user operating a Web browser executing on one of the client devices 120 can interact with the system 100 via the UI manager 415.

The API 416 provides programmatic access to one or more functions of the system 100. For example, the API 416 may provide a programmatic interface to one or more functions of the system 100 that may be invoked by one of the other programs 430 or some other module. In this manner, the API 416 facilitates the development of third-party software, such as user interfaces, plug-ins, adapters (e.g., for integrating functions of the system 100 into Web applications), and the like.

In addition, the API 416 may be in at least some embodiments invoked or otherwise accessed via remote entities, such as one of the client devices 120, one of the store information systems 110, and/or one of the third-party systems/applications 132, to access various functions of the system 100. As described above, a user operating one of the client devices 120 may import product location information data into the system 100 via the API 416. As another example, a search service executing on one of the third-party systems 132 may make product search queries via the API 416. The API 416 may also be configured to provide widgets (e.g., code modules) that can be integrated into the client devices 120 (or third-party systems 132) and that are configured to interact with the system 100 to make at least some of the described functionality available within the context of other applications (e.g., mobile apps).

In an example embodiment, components/modules of the system 100 are implemented using standard programming techniques. For example, the system 100 may be implemented as a “native” executable running on the CPU 403, along with one or more static or dynamic libraries. In other embodiments, the system 100 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Also, other functions could be implemented and/or performed by each component/module, and in different orders, and by different components/modules, yet still achieve the described functions.

In addition, programming interfaces to the data stored as part of the system 100, such as in the data store 420, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the system 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications, non-patent publications, and appendixes referred to in this specification and/or listed in the Application Data Sheet, including but not limited to U.S. Patent Application No. 61/576,616, filed on Dec. 16, 2011 and entitled “COLLECTING STORE AISLE LOCATION INFORMATION;” U.S. Patent Application No. 61/655,889, filed on Jun. 5, 2012 and entitled “GENERATING STORE AISLE SIDE SECTION LOCATION RELATIONSHIPS;” U.S. Patent Application No. 61/694,503, filed on Aug. 29, 2012 and entitled “SYSTEMS AND METHODS FOR MANAGING PRODUCT LOCATION INFORMATION;” and U.S. Patent Application No. 61/719,884, filed on Oct. 29, 2012 and entitled “SHELF EDITING COLLECTION (SEC) WITH A SMART LOCATION DEVICE,” are incorporated herein by reference, in its entirety.

From the foregoing it will be appreciated that, although specific embodiments have been described herein for purposes of illustration, various modifications may be made without deviating from the spirit and scope of this disclosure. For example, the methods, techniques, and systems for store aisle location information gathering are applicable to other architectures or in other settings. For example, instead of collecting information about the location of products on store shelves, at least some of the techniques may be employed to collect information about the location of books in a library or items stored in a warehouse. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method for managing product location information, the method comprising:
in a mobile computing device, receiving an indication of an initial position in a store, the indication of the initial position identifying a shelf or location that includes multiple items arranged in order from a first end of the shelf to a second end of the shelf;
receiving a series of item identifiers that each correspond to one of the multiple items, the item identifiers received from a scanner operated by a user who is traversing the shelf, in a right or left direction, from the first end to the second end;
receiving an indication that the user has reached the second end of the shelf; and
without receiving any additional inputs from the user, recording store aisle location information for each of the multiple items including, for each item, an aisle identifier, a side identifier, a section identifier, a shelf identifier, and itemization order.

2. The method of claim 1, further comprising: facilitating shelf-by-shelf collection of store aisle location information for items arranged on multiple shelves in the store, wherein, as each shelf is scanned, the user makes only a single input to the mobile computing device indicating that the beginning or end of the shelf has been reached.

3. The method of claim 1, further comprising: presenting on the mobile computing device a user interface configured to facilitate collection of store aisle location information for multiple shelves in the store by receiving only a single input from the user as each shelf or section is scanned.

4. The method of claim 1, wherein the receiving an indication of an initial position in a store includes: receiving an indication of a store aisle and an aisle section.

5. The method of claim 1, wherein the receiving a series of item identifiers includes: receiving the item identifiers in an order that matches the order in which the items are arranged on the shelf.

6. The method of claim 1, wherein the receiving a series of item identifiers includes: receiving the item identifiers from a hand-held barcode scanner operated by the user.

7. The method of claim 1, wherein the receiving an indication that the user has reached the second end of the shelf includes: receiving an indication that the user has selected a user interface control of the mobile computing device or a command barcode.

8. The method of claim 1, wherein the recording store aisle location information for each of the multiple items includes: transmitting the store aisle location information from the mobile device to a store inventory management system or point of sale system.

9. The method of claim 1, wherein the recording store aisle location information for each of the multiple items includes: transmitting, as each item is scanned, the store aisle location information corresponding to each item from the mobile device or scanner to a server where store aisle location information in maintained.

10. The method of claim 9, further comprising:
in response to the transmitted information, receiving from the server a product name or image; and
displaying the received product name or image on the mobile device.

11. The method of claim 1, wherein the recording store aisle location information for each of the multiple items includes: locally recording the store aisle location information on the mobile device for later bulk transmission to a store inventory management or point of sale system.

12. The method of claim 1, further comprising: scanning multiple shelves in a section having multiple shelves, by scanning a first shelf of the multiple shelves in a left-to-right fashion, and subsequently scanning a second shelf of the multiple shelves in a right-to-left fashion, the second shelf being immediately above or below the first shelf.

13. The method of claim 1, further comprising: adding store aisle location information for an item to be added at a location on a shelf of the store.

14. The method of claim 13, wherein the adding store aisle location information includes:
receiving an indication of an item that is currently located at the location on the shelf; and
assigning store aisle location information associated with the item that is currently located at the location on the shelf with the item to be added.

15. The method of claim 13, wherein the adding store aisle location information includes:
receiving an indication of an item that is currently located adjacent to the location on the shelf, wherein there is no item currently located at the location at the shelf;
determining store aisle location information for the item to be added based on the adjacent item; and
assigning the determined store aisle location information with the item to be added.

16. The method of claim 13, wherein the adding store aisle location information includes: providing a user interface configured to present information about items at or about the location on the shelf of the store, receive an indication of an item to be replaced, and associate store aisle location of the item to be replaced with the item to be added.

17-34. (canceled)

35. The method of claim 3-41, further comprising:
receiving multiple planograms that each include location information for multiple items in a store section;
for one of the sections in the aisle, receiving a scanned identifier of one item located in the one section;
determining one of the multiple planograms that includes the identifier of the one item; and
automatically populating a user interface display of the one section to present identifiers of other of the items in the one section, based on contents of the identified planogram, without requiring additional scanning to obtain identifiers of the other items.

36. The method of claim 1, further comprising:
providing a user interface that is configured to present information about products arranged on an aisle of a store, the aisle comprising multiple sections each having multiple shelves that include at least some of the products, by:
presenting a screen that includes a graphical depiction of the aisle, the graphical depiction including active elements corresponding to each of the multiple sections;
receiving an indication of a user selection of the active element corresponding to one of the multiple sections; and
in response to the received indication, facilitating access to information about the products on the shelves of the selected section, by:
presenting quantity information about the products on the shelves of the selected section;
presenting movement information about the products on the shelves of the selected section; and
presenting user interface controls configured to manipulate the information about the products on the shelves of the selected section.

37. (canceled)

38. The method of claim 36, further comprising: automatically determining a total number of facings in the section based on information obtained via a mobile device configured to scan product bar codes on the selected shelf and presenting indications of the total number of facings in the section.

39. The method of claim 36, wherein the presenting movement information about the products includes: presenting indications of at least one of a total number of new products in the section, a total number of products in the section that are moving at a normal rate, a total number of products in the section that are moving at a slow rate, a total number of products in the section that are discounted, a total number of products in the section that are discontinued, a total number of products in the section that have moved over a time period, and a gross sales amount for the products that have moved over a time period.

40. The method of claim 36, wherein the presenting movement information about the products includes: presenting a graph wherein different colors are used to indicate how many items are new, moving at normal speed, moving at slow speed, discounted, and/or discontinued.

41-50. (canceled)

51. A method for managing product location information, the method comprising:
managing location information about products arranged on an aisle of a store, the aisle comprising multiple sections each having multiple shelves that include at least some of the products and that each have an associated machine-readable location indicator, by:
receiving an indication of a location corresponding to a first one of the shelves, the indication received from a scanner operated by a user to scan the associated machine-readable location indicator;
receiving one or more indicators of products on the first shelf, the indicators received from the scanner operated by the user, wherein the user did not perform any additional data entry operations after scanning the machine-readable location indicator;
recording the received product indicators in association with location information for each of the products, based on the received location information; and
preparing to record product indicators for a second shelf.

52. The method of claim 51, wherein the preparing to record product indicators for a second shelf includes: receiving an indication that the machine-readable location indicator has been rescanned, receiving an indication that a second machine-readable location indicator located at the other end of the first shelf has been scanned, and/or receiving an indication that a second machine-readable location indicator associated with the second shelf.

53. The method of claim 51, further comprising: attaching machine-readable location indicators to each of the shelves in the store.

54. A system for managing and/or accessing store aisle location information, the system comprising:
a processor;
a memory; and
a module that is stored in the memory and that is configured, when executed by the processor, to:
manage location information about products arranged on an aisle of a store, the aisle comprising multiple sections each having multiple shelves that include at least some of the products and that each have an associated machine-readable location indicator, by:
receiving an indication of a location corresponding to a first one of the shelves, the indication received from a scanner operated by a user to scan the associated machine-readable location indicator;
receiving one or more indicators of products on the first shelf, the indicators received from the scanner operated by the user, wherein the user did not perform any additional data entry operations after scanning the machine-readable location indicator;
recording the received product indicators in association with location information for each of the products, based on the received location information; and
preparing to record product indicators for a second shelf.

55. The system of claim 54, wherein the memory is part of a mobile device coupled to a barcode scanner, and the module is configured to:
receive product identifiers from the barcode scanner; and
determine store aisle location for items identified by the product identifiers.

56. The system of claim 54, wherein the memory is a memory in a server computer that is configured to provide access to product location information to remote client computing devices.

57. The system of claim 54, wherein the memory is a memory in a mobile device that is configured to gather product location information by reading bar codes in a retail location.

58-61. (canceled)
